(19) United States
(12) Patent Application Publication
(10) Pub. No.: US 2026/0359664 A1
(43) Pub. Date: Nov. 12, 2026

(54) Self-Building Internode Network Systems and Bounded Computational Units

(71) Applicant: Robo.bot, Inc. DBA Creature Algorithm, Mountain View, CA (US)

(72) Inventors: Maurits Sebastiaan Joseph Tepaske, Leiden (NL); Marius Lukas Veselis, Portola Valley, CA (US); Asteras Gura, Mountain View, CA (US)

(21) Appl. No.: 19/670,905

(22) Filed: May 7, 2026

Related U.S. Application Data
(60) Provisional application No. 63/803,341, filed on May 9, 2025.

(51) Int. Cl. G06N 3/10; G06N 3/092

(52) U.S. Cl. CPC G06N 3/10; G06N 3/092

(57) ABSTRACT

An exemplary self-building internode network system includes a plurality of internodes, a sensor and motor, and a self-building network module coupled to the plurality of internodes, the sensor and the motor. The self-building network module implements an automatic experience-driven network construction algorithm for network building. The self-building network module initiates staged internode spawning of the internodes. The network system produces actions through the motor to create learned behaviors and memories. Learned behaviors and memories reside solely in a network topology, connection strengths, and transient node states, without external memory or a central control unit. Another embodiment provides a primitive bounded computational local unit. The unit includes viability variables and operates in a local state corresponding to viability. Structural adaptations are made at the boundary, based on the unit's state history and local physical residues. Higher-level network behavior emerges from boundary-level rules that use the plurality of viability variables.

### CROSS-REFERENCE TO RELATED APPLICATIONS

This application claims the benefit and priority of U.S. Provisional Application No. 63/803,341, filed May 9, 2025, entitled “Autonomous Robot System Incorporating an Automatic Experience Driven Network Building,” which is hereby incorporated by reference herein in its entirety.

### FIELD

This disclosure relates to systems and methods for providing an autonomous self-building internode network that incorporates an automatic experience driven network builder. In some embodiments, the internode network is a self-building number-processing network system that is built based on internally generated reinforcement from sensory processing of the sensor, network activity of the plurality of internodes, and reflex-first learning in which reflexive behavior precedes higher-order processing structures. In other embodiments, the autonomous self-building internode network is connectively coupled with a robot having a robot body that comprises a plurality of sensors and a plurality of motors. The autonomous self-building internode network is useful in such areas as artificial intelligence and computing networking topology. In further embodiments, a more primitive class that is also useful for computer networking is based on local units and substrates, where a local unit is bounded by a boundary that separates the unit from its medium. Structural adaptations occur at the boundary and inside of the unit as the local unit is influenced by its surroundings and responds to it based on viability.

### BACKGROUND

Traditional artificial intelligence systems have generally relied on centralized architectures, where processing is performed by a core computational unit supported by memory banks storing learned information. Machine learning techniques, including deep neural networks, often require extensive training using backpropagation algorithms, significant computational resources, and fixed network topologies predesigned by human experts. Such approaches necessitate substantial computational overhead, external supervision, and explicit optimization calculations that limit adaptability, which equate to significant obstacles in the fields of network topology and computer networking.

### SUMMARY

Systems and methods of establishing self-building internode network systems are described. In one aspect, a self-building internode network system includes a plurality of internodes, including input nodes and output nodes; a sensor and a motor coupled to the plurality of internodes; and a self-building network module. The self-building network module is operatively coupled to the plurality of internodes, the sensor and the motor. The self-building network module is configured to implement an automatic experience-driven network construction algorithm to build the network system based on internally generated reinforcement from sensory processing of the sensor, network activity of the plurality of internodes, and reflex-first learning in which reflexive behavior precedes higher-order processing structures. The self-building network module is further configured to initiate staged internode spawning of the plurality of internodes based on causal firing activity between the plurality of internodes, local activity traces, causal activity relationships, co-activation history, or other locally available interaction-derived signals. The self-building network module includes an adaptive threshold scaling based on total incoming edge strength of a given internode. The adaptive threshold scaling is configured to stabilize firing activity of the given internode.

The self-building internode network system is configured to interact within an environment that the self-building internode network system experiences only through the sensor and in which the self-building internode network system produces actions through the motor to create learned behaviors and memories. The learned behaviors and memories reside solely in a network topology, connection strengths, and transient node states of the plurality of internodes that are produced and driven by positive or negative experiences of the network system in the environment as derived from the sensory processing, without external memory or a central control unit.

In another aspect, a method for building a self-building internode network system is provided. The method begins with establishing a plurality of internodes, having both input nodes and output nodes. The method continues with interacting within an environment that is experienced through neuromodulator node activity, sensed through a sensor, and producing actions through a motor, which collectively create learned behaviors and memories. The method further includes reinforcing the learned behaviors and memories based on neuromodulator node activity, through the sensory processing of the sensor, network activity based on activity of the plurality of internodes, and reflex-first learning that expands into higher-order structure and viability history. The method includes staged internode spawning of the internodes based on causal firing activity between the plurality of internodes, local activity traces, causal activity relationships, co-activation history, or other locally available interaction-derived signals.

In yet another aspect, a bounded computational unit is provided. The bounded computational unit includes an interior, an exterior, and an interface through which exchange occurs that includes a boundary having boundary segments. The bounded computational unit comprises a plurality of viability functions. The computation local unit operates in a local state that corresponds to viability. The boundary segments, and potentially other parts of the unit as well, including internal parts, are adaptable based on boundary-based viability regulation, the unit's state history, and local physical residues within the computational local unit. The plurality of viability functions is configured to directly govern operations of the computational local unit. Higher-level network behavior of the computational unit emerges from boundary-level and internal-level rules that use the plurality of viability variables.

### BRIEF DESCRIPTION OF THE DRAWINGS

FIG. 1 is a system architecture diagram illustrating a self-building internode network system, according to an embodiment.

FIG. 2A-2T are screenshots of certain exemplary stages of an automatic experience-driven network construction algorithm, according to an embodiment.

FIGS. 3A-3J are screenshots of exemplary embodiments utilizing a self-building internode network system.

FIG. 4 is a flowchart illustrating a method utilizing an automatic experience-driven network construction algorithm, according to an embodiment.

FIG. 5 is a block diagram illustrating a bounded computational unit, according to an embodiment.

FIGS. 6A and 6B are screenshots of a bounded computational unit, according to an embodiment.

FIG. 7 is a schematic diagram of an example computer system that can be used in embodiments of the present disclosure.

### DETAILED DESCRIPTION

### Overview

To address the limitations and challenges that are posed by existing artificial intelligence (AI) systems, the present disclosure introduces a self-building internode network system that incorporates an automatic experience driven network builder. The self-building internode network system encapsulates a new class of biology-inspired artificial intelligence that goes beyond traditional backpropagation approaches. Simply put, the present disclosure describes a self-building internode network system that utilizes the first AI architecture that is capable of operating without the traditionally restrictive fundamental pillars of standard machine learning, such as predefined network structures, explicit loss functions, human-crafted rewards and goals, or fitness metrics. Instead, the self-building internode network system builds connections entirely on its own through continuous trial and error, reinforcing behaviors that work and dropping those behaviors that do not work—similar to how animals learn without explicit feedback.

The present disclosure further provides description of a more primitive architectural embodiment. This more primitive architecture utilizes a substrate in which each local unit is itself more body-like (or cell-like). The local unit has an inside, an outside, a boundary, usable resource, spent burden, and local ways of changing and adapting its structure based on interactions with the medium around it. This embodiment is not just a network of nodes adjusting parameters, but rather a bounded local viability-bearing process that begins to shape its own exchange and structure through interaction with the world. With this embodiment, the local units themselves become more explicitly viability-bearing, body-medium-coupled, consequence-resolving, and capable of local structural specialization through lived resource/burden dynamics. This more primitive embodiment is that of a more primitive class of units and substrates from which such systems can arise. A membrane-bounded computational unit having a membrane as a boundary is one specific embodiment of this more primitive architecture. All of this and more will be discussed in greater detail later herein.

There are a number of significant technical computing advantages of the self-building internode network system and the more primitive system over and above what is offered by conventional networking and AI-based systems. First, both systems of the present disclosure do not require extensive training or deep neural networks to function. In fact, both systems allow for dynamic, on-the-fly reflex-first learning, so no prior training and no huge datasets or memory banks for storing learned information are needed for these innovative systems to function. Second, both systems of the present disclosure require very limited computational resources and overhead, and therefore they can be fully operational in a relatively short amount of time, as will be evident based on the description provided below. Third, the systems described herein do not require much, if any, external supervision to operate smoothly, and the systems are easy to set up with very little time required. Fourth, the intelligence or the “brain” of the network systems can be transferred from one body/structure to another (such as a transfer from a first robotic car to a second robotic car or even to a robotic vacuum). Fifth, the systems do not require fixed network topologies that utilize complex multi-level computing algorithms. Instead, the present disclosure provides simpler, less complex algorithmic details and processes on how each system expands over time incrementally and changes by way of local rules first structural adaptation based on transient node states and viability histories, and then growth by layers. Sixth, as will be evident in the present disclosure, none of the systems or methods described herein require an external memory or a central control unit, which is quite revolutionary. Seventh, the systems and methods of the present disclosure are agnostic in terms of implementation. As a non-limiting example, they can be implemented in a virtual fashion, they can be implemented in the form of nested multi-sensor logic gates, or they can be implemented on a network chip or other hardware. Finally, the systems and methods described herein are based on event-based learning based primarily first on reflexes or firing of nodes, as opposed to learning based on stored machine-learned data patterns or trained datasets from an AI model.

In a first embodiment, the present disclosure addresses the limitations and challenges in traditional artificial intelligence by providing a self-building internode network system comprising one or more sensors and one or more motors operatively coupled to a self-building network module that implements an automatic experience-driven network construction algorithm. While general descriptions of sensors and motors are used as examples, the present disclosure can be used with any controllable device that can be managed by a computing device. In other embodiments, the present disclosure can be used in the context of any general input system and/or output system. For instance, the present disclosure can be used with systems that are entirely digital (such as systems and methods for inputting and outputting numbers).

Typically, the self-building internode network system (hereinafter referred to also as “the internode network system” or “the network”) is situated in an environment, which the internode network system knows or experiences only through the sensors, and in which the internode network system can produce actions through its motors. As will be described later herein, initialization of the self-building network module of the internode network system can be accomplished in a number of ways and is not limited nor restricted to a given set manner or setup. Further, the physical network develops incrementally from a chosen starting configuration. This flexibility in initialization enables the internode network system to adapt to different learning scenarios and environmental requirements.

By way of example, in some embodiments, if no edges are initialized, or no nodes or connections initially exist, and a high network complexity cap is chosen, the internode network system can start forming internodes immediately. That is, the network is configured to start from an absolute blank slate with no initial connections whatsoever, where connections are formed entirely from scratch based on the network's environmental interactions. The present disclosure can also include other embodiments in which upon initialization, the self-building network module establishes only direct reflexive pathways between the one or more sensors and the one or more motors. In some embodiments, an administrator can choose any initial network, reflexive or higher order. The present disclosure also includes exemplary embodiments in which the automatic network building can be paused at one or more times. Further, the present disclosure also allows for the system to add/remove or suppress/amplify any connections and nodes. The automatic network building will simply continue from there when it has been re-enabled. It should also be noted that with the internode network system, new internodes arise from prior local activity and interaction history (i.e., activity/trace/causal co-activation conditions), rather than from a predesigned fixed graph or a global controller deciding to add nodes. This is one of the several sea-change improvements above and beyond traditional or conventional systems which will be described later herein.

As the internode network system interacts with its environment, sensor-triggered network activity both generates internal reinforcement signals and autonomously instantiates new internodes and/or edges, incrementally forming higher-order processing structures. The AI architecture enforces staged complexity. The AI architecture may start with a very simple beginning (such as reflex-only behavior initially) or a simple internode structure, and then later, the AI architecture can build or expand upon the simple beginning or structure to something far more complex, such as a large-size network. The specific stages provided by the AI architecture will be described later herein in great detail, for exemplary purposes.

Further, with the internode network system, simple reflexive behaviors must first yield positive experiences and/or negative experiences before a complex, adaptive structure emerges to govern motor outputs. Examples of such complex adaptive structures include, but are not limited to, nested multi-sensor logic gates. It should be noted that the exemplary nested multi-sensor logic gates are only a very small subset of all the networks that can arise from the self-building network module. It will be understood that logic gates serve only as conceptual examples, and that the present disclosure is not restricted to logic gates. The positive experiences and/or negative experiences of the internode network system can result in network building and may even result in any number of new network structures, edges and/or nodes. Thus, as an example, if the internode network system is exploring its environment with a simple reflexive network, and then the network complexity cap is upgraded while performing some negative reinforcement routine, an inhibitive network structure may form or build on top of the simple reflexes.

An adaptive threshold controller within the self-building network module adjusts each node's activation threshold to stabilize network growth as complexity increases. Further, the self-building network module can accomplish adaptive threshold scaling based on total incoming network edge strengths. Thus, no external memory or central control unit is required, since the internode network system's learned behaviors and its “memories” can reside solely in the network topology, the strengths of its connections, and the transient node states. This fully decentralized on-board learning and adaptation capability enables the internode network system to acquire and refine complex behaviors through environmental interaction alone.

This internode network system achieves experience-driven learning organically through local properties, such as connection strengths and node activation thresholds, and global properties, such as network topology. More specifically, the present disclosure concerns an internode network system that embodies decentralized adaptive learning without reliance on traditional centralized processors, external memory, and/or floating-point computation.

The present disclosure also contemplates examples in which the internode network system demonstrates self-preservation mechanisms or learns such self-preservation behaviors. For instance, the internode network system may learn harm avoidance behaviors that emerge incrementally from reflex-driven behaviors. The internode network system may also demonstrate damage prevention behaviors through internally generated negative reinforcement signals. Further, the internode network system's evolution over time may include the emergence of an automatic, experience-based protective reflex. All of these self-preservation examples and more are within the scope of the present disclosure

Also, the present disclosure contemplates embodiments of a self-building number-processing network system. In those embodiments, the system includes a plurality of input nodes and a plurality of output nodes and a self-building network module. The self-building network module is configured to implement an automatic experience-driven network construction algorithm. The self-building network module is operatively coupled to the plurality of input nodes and the plurality of output nodes. The automatic experience-driven network construction algorithm is configured to build the self-building number-processing network system based on all network activity including activity of the plurality of input nodes and the plurality of output nodes. Although much of the present disclosure describes an internode network system having one or more sensors and motors, it can be appreciated that the teachings regarding the internode network system can also apply in these embodiments regarding a self-building number-processing network system.

It can also be appreciated that although the present disclosure contemplates embodiments in which the system can be implemented on a physical network chip, the present disclosure is not limited to just a network chip. In fact, the system of the present disclosure can be entirely virtual. Alternatively, the system can also run on a traditional CPU/GPU +memory computer, in which case the network is held in classical memory instead of being manifested physically. Then the network activity and building must be simulated, for which the input values need to be fed into this virtual network. The virtual output can then be sent to the physical motors to produce output. This way, the internode network system can also function without a network chip.

The present disclosure can include further embodiments which are entirely virtual on a traditional computer, with no physical sensors and motors. In those embodiments, the system would run as a traditional application, where software feeds numbers into the virtual network, with the output numbers then used in other software. Furthermore, the present disclosure includes systems and methods for building networks that can operate in distributed systems (e.g., smart cities, autonomous fleets). It can also be appreciated that the systems and methods described herein can apply to distributed artificial intelligence.

### Exemplary Embodiments of a Self-Building Internode Network System

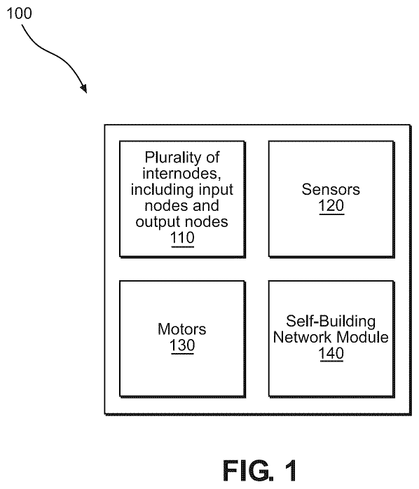

FIG. 1 depicts a system architecture diagram illustrating an exemplary self-building internode network system 100. Specifically, FIG. 1 depicts the architecture of a self-building internode network system 100 in which discrete nodes (representing sensors, motors, and internodes) form and modify connections autonomously through experience-driven interaction with an environment, without reliance on backpropagation, predefined network structures, explicit loss functions, or human-crafted reward signals. Reinforcement arises internally from the network's own processing of sensory input, and structural adaptation proceeds incrementally: simple reflexive pathways must yield positive or negative experiences before higher-order processing structures (such as nested multi-sensor logic gates or other complex topologies) can emerge. Each node maintains local activity traces that serve as a transient memory of prior signaling, enabling the node to determine which structural modifications to make when a reinforcement-triggering event occurs. A network complexity cap governs staged growth, restricting internode spawning to defined layers (e.g., internodes between sensor-motor pairs before internodes between internodes), and an adaptive threshold controller adjusts each node's activation threshold based on total incoming edge strengths to stabilize the network as it scales.

Referring still to FIG. 1, the exemplary self-building internode network system 100 of the present disclosure comprises a plurality of internodes 110, one or more sensors 120 and one or more motors 130, and a self-building network module 140. The plurality of internodes can include both input nodes and output nodes. Examples of robotic nodes include a touch sensor node, a retina sensor node, a temperature sensor node, and a left arm bicep motor node. Digital examples of nodes include a function current value input node and a function multiplication factor output node.

An intermediate internode is a node that has synaptic and/or neuromodulatory input and output channels, whereas a sensor internode only has neuromodulatory input and synaptic output while a motor internode only has synaptic and neuromodulatory input. A sensor internode furthermore takes analog or digital sensor values as input while the motor internode furthermore produces analog or digital output that is fed to a motor. Alternatively, an internode can be a node, an edge, or any combination thereof. The nodes can be network nodes. As will be described in relation to the exemplary self-building internode network system 100 and FIG. 1, viability-regulated local adaptation is expressed through discrete network nodes and connections.

The self-building network module 140 is operatively coupled to the plurality of internodes 110, the sensor(s) 120 and the motor(s) 130. The self-building network module 140 is configured to implement decentralized adaptive learning. In other embodiments, the self-building network module 140 essentially works on the level of single nodes, where each node decides on its own whether it wants to do any local building operations and only being “instructed” by neuromodulator signals. As noted earlier, using the self-building internode network system 100 described herein, new internodes arise from prior local activity and interaction history (i.e., activity/trace/causal co-activation conditions), rather than from a predesigned fixed graph or a global controller deciding to add nodes.

The self-building network module 140 is further configured to implement an automatic experience-driven network construction algorithm to build the self-building internode network system 100 based on internally generated reinforcement from sensory processing of the sensor(s) 120, network activity of the plurality of internodes 110, and reflex-first learning in which reflexive behavior precedes higher-order processing structures. In some embodiments, the internally generated reinforcement can be internal signals that are generated by dedicated neuromodulator nodes that function like output nodes (that is, having no synaptic output, only neuromodulators) that affect the internal workings or environment of the system 100, instead of its external environment.

The self-building network module 140 is further configured to control structural adaptation through the edge creation/deletion/modification and internode spawning/removal/modification of the plurality of internodes 110 based on the causality of its constituents, such as the causal firing activity between internodes, local activity traces, causal activity relationships, co-activation history, or other locally available interaction-derived signals. In some embodiments, the self-building network module 140 further includes an adaptive threshold scaling based on total incoming edge strength of a given internode. “Causal firing activity between internodes” as used herein means the causal correlation between two nodes. This is called the Hebbian principle. For example, if one node is consistently firing before another, such that it looks like one is causing the other to fire, then their causal correlation is positive. If, instead, the other seems to fire earlier, then the causal correlation is negative. This correlation information is stored in a decaying trace. If a neuromodulator arrives, this trace is converted into a new network element, such as an edge, and the strength of that new edge is determined by the causal correlation trace together with the specific nature of the neuromodulator.

The adaptive threshold scaling is configured to stabilize firing activity of the given internode. That is, the adaptive threshold scaling is based on threshold scaling with total incoming edge strength of a given internode, which stabilizes firing activity or activity patterns of the given internode as network structure changes. That firing behavior affects local activity traces, and those traces then participate in structural growth (e.g. staged internode spawning). This is another causality aspect: when causal activity, as encapsulated in a causal activity trace, seems to cause a certain reinforcement signal, then structural modifications occur that suit the nature of the reinforcement signal.

The threshold scaling determines the firing threshold of a node, which determines how much input it needs to receive before it sends out a spike. The adaptive threshold ties in with the activity of nodes, which in turn determines the activity traces. Edges and internodes are spawned and modified based on these activity traces, which can, for example, measure the causal correlation between two nodes. Using the self-building network module 140, simple behaviors and network structures necessarily precede more complex behaviors and network structure.

As these activity traces are converted into network components, the total incoming edge weights of some nodes change, such that the firing thresholds of those nodes also change due to the adaptive threshold mechanism. This is done in a way that stability is likely maintained, such that the node does not start to fire uncontrollably as it is accumulating more and stronger edges.

The self-building internode network system 100 is configured to interact within an environment that the self-building internode network system 100 experiences only through the sensor(s) 120 and in which the self-building internode network system 100 produces actions through the motor(s) 130 to create learned behaviors and memories. It should be noted that in some embodiments, the self-building internode network system 100 does not need motors in order to form new network components (e.g., to form new behaviors and memories). If the self-building internode network system 100 has sensors and internodes, then if the sensor activity causes internode activity, and also causes a neuromodulator node to fire that induces network building, then new components will be inserted only between sensor and internodes.

The learned behaviors and memories reside solely in a network topology, connection strengths, and transient node states of the plurality of internodes 110 that are produced and driven by positive or negative experiences of the network system 100 in the environment as derived from the sensory processing, without external memory or central control unit. In some embodiments, the experience can even be a mixture of both positive and negative experiences. In other embodiments, the experience can be either pleasure or displeasure. In yet other embodiments, causal-correlation-amplifying experience or causal-correlation-suppressing experience may be the driving force. This relates directly to how these experiences, and the associated neuromodulators in particular, relate to the node operations that they induce.

As an example, with a positive experience, edges and nodes can be inserted and removed, and existing edges can be modified, such that the causal correlation between the source and target nodes likely increases. A positive experience may be manifested by a positive neuromodulator. Likewise, with a negative experience, edges and nodes can be inserted and removed, and existing edges can be modified, such that the causal correlation between the source and target nodes likely decreases. A negative experience may be manifested by a negative neuromodulator, in which its aim is to reduce the causal correlation between source and target through the network operations.

Learned behavior can reside in the evolving network structure and local node states. When similar situations recur, previously formed circuits reactivate and reproduce behavior directly, without a central memory store, replay mechanism, or controller.

Initially, the sensor(s) 120 and motor(s) 130 are coupled via simple edges, which transmit information of the sensing events from the sensor(s) 120 to motor(s) 130. Such signaling can cause a motor 130 to be activated, which can result in an action, such as moving the internode network system 100 within its environment.

As an example, a heat sensor of the internode network system 100 can be coupled to a move-backwards motor, such that encountering heat will cause the internode network system 100 to move backwards, which is a simple reflex. If the edge-only switchboard is turned into a network with intermediate nodes, where information processing is achieved through the properties of the network 100 and its constituting internodes 110, then the behavior of the internode network system 100 may invariably become more complex. In that case, sensor information likely must be transmitted through many network internodes 110 before it reaches the motors 130. At each internode, this signal now is affected by all of the other incoming signals of that internode such that hierarchical processing of multiple sensor signals is now a possibility. For example, a XOR gate can be calculated on two Boolean sensor values S1 and S2, with outcome XOR(S1,S2), and another XOR gate can be calculated on S3 and S4, yielding XOR(S3,S4), and now one may want to determine if a motor should get activated by the outcome of the nested XOR function XOR(XOR(S1,S2), XOR(S3,S4)). This is possible only when the switchboard between the sensors and motors is allowed to be a network.

In some embodiments, the internode network system 100 begins with a reflex-only switchboard, which can be chosen by a human or an administrator. In order for the internode network system 100 to acquire supra-reflexive behavior, the internode network system 100 only needs to experience its environment, and the internode network system 100 can be left completely alone. As its environment fluctuates, the sensors 120 can be activated at times, which induces network activity, resulting in a motor output of the internode network system 100 and sometimes a neuromodulator output as well, which is crucial for the network building operations to be triggered. After executing the motor output, new sensory information arrives, likely changing the network activity and hence also the motor output of the internode network system 100.

This network activity is all that is needed for the internode network system 100 to learn. The internode network system 100 only needs to experience its environment. Other than experiencing the sensor activity as it occurs, no traditional storage of the sensor activity is needed nor contemplated. Traditional memory storage and floating point information processing are entirely absent, except for what currently happens at each sensor 120, motor 130, or internode 110 in the network 100. The traditional robotics setup with a central processing unit and traditional memory is replaced by network activity. The only remaining computation occurs at each network internode 110, which activates itself depending on a simple condition on its inputs and also keeps track of the activity traces and the network building operations. The simultaneous dynamics of this collection of very simple nodes, which can be simulated or hosted on a network chip, gives rise to emergent phenomena that can be harnessed to produce complex behavior.

In some exemplary embodiments, the internode network system 100 is built automatically, starting from the reflex-only switchboard, as the internode network system 100 experiences its environment. As the internode network system 100 moves around, the internode network system 100 will encounter positive and negative experiences or sensations, which will drive the particular ways in which the internode network system 100 is formed from such activity. These positive and negative sensations also arise entirely from the network activity, not requiring any external reinforcement signal. Instead, the reinforcement signal that the internode network system 100 receives is implicit in the sensor data provided by the sensor(s), and the reinforcement signal arises only after the network has processed the sensor data. In other words, for the internal reinforcement signal to arise, there needs to be some external sensory input which through the internode network system's past experience or through hardcoding by the human operator has become associated with reinforcement. Hence, the internode network system's environment (which is manifested as the sensory input) is a part of the self-building of the internode network system 110. Furthermore, especially if the network is big, activity deep in the network can cause the reinforcement signal to arise. All internal activity can ultimately be traced to sensor input, but the reinforcement signal does not need to be directly caused by sensor input. In fact, often the reinforcement signal results from a mix of new sensor input and existing network activity, which may occur through neuromodulator nodes.

It should be noted that the positive and negative experiences are ultimately derived from the sensory input and caused by network activity, but they only become positive or negative due to the processing of the internode network system 100. Through experience and the associated network building, the internode network system 100 starts to produce positive and negative reinforcement signals for certain sensory inputs. As described earlier herein, signals are produced by an experience of pleasure or displeasure, where neuromodulator nodes have synaptic input and also neuromodulator input because they are involved in network building, as well as neuromodulator output. In other embodiments, signals are provided by an experience of pleasure or displeasure, through avoidance-learning-specific nodes that only take neuromodulators as input and output.

As the internode network system 100 becomes more complex, with complex network structures providing the input for the internode network system 100 internodes that emit the positive or negative building signal, the positive or negative sensations become more and more complex, and can become more and more distantly related to the primitive negative/positive sensations, such as consuming food or energy and avoiding poison or obstacles (or, if the internode network system 100 is implemented in a robot having a robot body, the robot may clean dust and avoid shocks). This way, an AI agent (i.e., the internode network system internode network system 100 or the robot) can become motivated in increasingly complex ways, also opening up the door for pathological effects, such as becoming motivated by sensations that ultimately do not provide the sustenance to thrive or even survive.

Variability also provides another drive on the learning and behavior (i.e., on the local building operations of each node) alongside the positive/negative/global neuromodulator signals. Depending on the viability state of a node, it will “interpret” neuromodulator signals differently, for example, and in one state it might insert an excitatory edge while in another state, it may insert an inhibitory edge. Each node has a basal cost, including for example an amount of energy that it needs to spend in order to maintain its current structures. The network modifications will seek to promote behavior that leads to positive sensations and suppress behavior that leads to negative sensations. As the internode network system 100 grows, the positive and negative sensations themselves can become more and more nuanced, determined entirely by network activity as well. Behavior will be promoted that leads to the avoidance of negative sensations. Also, besides reinforcing network building, there are many mixed types of non-synaptic signals that have other functions on the network, such as reinforcing the network and sometimes affecting the excitability of the network. There may be many receptors for these non-synaptic signals on each node. Non-synaptic signals are broadcasted by the neuromodulator node to a subset of the nodes (e.g., nodes that are relatively close to it).

The network formation and in turn the behavior learning (specifically, the reflex-first learning) are incremental, since simple network structures must precede more complex structures.

The internode network system 100 is a system in which behavior and learning arise from strictly local regulation under viability constraints, without reliance on global objective-driven optimization. The system operates such that action generation and structural adaptation are governed locally; no global reward, loss, value function, or trajectory evaluation coordinates behavior exists; viability is enforced as a boundary condition on what can persist, not as a quantity to optimize; and memory is retained in structure, and structure directly determines behavior. It will be understood that each node has viability variables and its operations (including energy uptake from bloodstream that can be coupled to a robot battery) form a viability regulation mechanism which directs the node behavior. For instance, the node behavior may include the node's building operations following pleasure. Or sometimes the node may perform a building operation without any reinforcement signal.

Furthermore, it should be noted that each node of the input nodes, output nodes, and internodes can operate or be in one of four transient node states. The four transient node states are based on two factors: the node's deviation from a viability range, e.g. above/below/outside the range; and the node's direction of change of that deviation, e.g. moving toward or away from viability. Thus, the four transient node states include the following: a first viability state when the node deviates below a viability range and moves away from viability; a second viability state when the node deviates below a viability range and moves towards viability; a third viability state when the node deviates above a viability range and moves away from viability; and a fourth viability state when the node deviates above a viability range and moves towards viability.

There are other notable core characteristics of the internode network system 100. First, it implements local regulation. That is, each node updates or changes its configuration only based on locally available information at the point of interaction. The operations of a node affect its viability and thereby determine its state. Crucially, here also the environmental influence is important. If resource transport to the node slows down, as a result of decreasing battery for example, then the node's viability will likely decrease as a consequence. So the viability of a node is also affected by the environment of a node, such as the other nodes or the characteristics of its energy supply. Learning occurs through local changes in thresholds, couplings, exchange, boundary behavior, or structure, without centralized optimization. There is no centralized controller deciding updates or actions. Second, as mentioned earlier, there is an absence of global objective coordination. The internode network system 100 contains no mechanism that accumulates a scalar performance signal across time, compares alternative trajectories or actions, or optimizes behavior via global evaluation. Third, the internode network system 100 implements structure as memory. Learned behavior is encoded in connectivity and persistent parameters. There is no separate policy or memory module. Fourth, the internode network system 100 has embodied coupling. Sensors and actuators are directly coupled into the internode network system 100, such that behavior emerges from ongoing interaction with the body and environment. Fifth, the internode network system 100 has action without predefined primitives. The internode network system 100 defines sensors and actuators, not discrete action tokens. Coordinated motion emerges from local interaction. Sixth, the internode network system 100 embodies viability as constraint. One example of a viability variable is energy as a viability variable. If the energy of a node is far below its viability range, then a local node operation, such as edge insertion, will be carried out differently than if the energy would be above the viability range. Similarly, if the energy is above the viable range, then it matters whether it is moving away or towards the viability range, which again define two different sub-regimes inside of the above-viability regime. This way we get four different viability states. So, the node operations are carried out differently within each state in order to promote viability regulation, where the energy of a node tries to stay in balance around its viable range. The internode network system 100 does not trade present instability for future gain, in contrast to algorithms that employ global objective optimization.

Furthermore, the internode network system 100 begins at a generative layer of action—where regulation enforces bounded interaction—and allows higher-order structure to emerge from that substrate. Regulation of viability ensures that the learning and behavior of a robot (having an internode network system 100) is naturally constrained to take into account the bodily state of the robot, such as its available energy, its body temperature, and outside influence that can cause phenomena such as deformation captured at the sensors. When considering bounded computational units, an external influence might cause the robot-environment border that surrounds the internal medium to deform, causing the medium to deform as well, which affects the viability of the units that occupy the medium. So in that sense such deformation is a similar influence as the resource or waste flow. Crucially, regulation happens on the level of single nodes, so each node is simply trying to regulate its viability, which, for example, has to regulate its energy expenditure and waste levels. The viability state of the node has a big influence on the node behavior, essentially directing it, such as determining how it reacts to synaptic and neuromodulator inputs. It can, for example, also influence the firing threshold of a node, making it more or less excitable depending on its state. It also directs local node operations such as node and edge insertion, and modification of existing edges. Thus, the network operations are considered to essentially derive from the four-state rules that are based on regulation of viability. In other embodiments, the network operations can be derived from a defined static set of network rules that is independent of viability. This is how bounded interaction, and the many interesting behavioral properties that are associated to it (such as withholding behavior in the presence of adversity), can stem from local regulation.

The internode network system 100 implements memory as stabilized structure. This stabilized structure is tightly intertwined with the history of regulation at the local nodes, just as it is tightly intertwined with the history of neuromodulators and the history of synaptic input. For example, if they were always below the viability range, then different structures will arise as opposed to the structures that would arise if they were always above the viability range.

The internode network system 100 learns what gravity and touch mean by remaining viable under them. The consequence is that what is stored is not a task description, but stabilized coordination itself. There are no internal tokens for “drive,” “grasp,” or “steer.” What persists are viable sensorimotor coordination regimes under load. Examples include: activation patterns that maintain balance under gravity, coordination patterns that regulate contact force, without overload, and corrective dynamics that restore bounded motion after perturbation. In each of these examples the learned behavior provides local viability regulation and enhances stability of the internodes of the internode network system 100. It should be further noted that the viability rules and their structural consequences can cause these stability-ensuring patterns to arise. An example of a learning trajectory that proceeds as layered physical coherence due to viability regulation adaptation is:
1. Baseline Stability (motion without collapse)
2. Contact Regulation (suppression of destabilizing collision)
3. Recovery Patterns (re-balancing under perturbation)
4. Composite Coordination (recombination of stabilized primitives)
   Structural change refers specifically to modification of connectivity or persistent node parameters. Transient fluctuations in activation, viability, or excitability are dynamical, not learning. Memory resides in retained structural modification. Importantly, the network is not structurally static. As experience accumulates, it can continue to grow through addition of nodes and edges, expanding its representational and coordination capacity. New structure forms alongside existing structure rather than overwriting it. Old structures can also “erode” and get deleted over time. This structural expansion reduces interference between earlier and later stabilizations. Layered stabilization further mitigates catastrophic forgetting. Foundational coordination regimes remain embedded in established substructures, while higher-order structure can be enabled or grown on top of them as environmental complexity increases. New behaviors therefore emerge through extension rather than global retuning. When learning is paused, structural change halts, whereas behavior persists because it is embedded in connectivity rather than maintained by ongoing optimization.

Notably, the internode network system 100 can be tested for failure modes. The internode network system 100 fails (or the failure mode has been activated) if its behavior collapses into task-specific tuning, requires retraining to adapt, fails to remain coherent when learning is paused, or exhibits global objective computation (return accumulation, trajectory ranking, or system-wide performance evaluation). The empirical claim is inconsistent if behavioral coherence degrades when structural updates are paused, stability depends on ongoing optimization or external supervision, or structural adaptation converges to a fixed controller independent of continued interaction. These conditions are inspectable through runtime logs, scaffold toggles, ablation protocols, actuator-command provenance tracing, and versioned builds. If any of the above mechanisms are identified in audit of a tested architecture, the tested architecture has failed, the conditions are falsified, and the tested architecture no longer meets the requisites of the internode network system 100.

As an example, the internode network system 100 can be tested using these conditions: control rates in the low single-digit Hertz range, latency in the hundred-millisecond range, CPU usage within a fraction of a single core, and a stabilized network of 1,204 nodes (376 k excitatory, 347 k inhibitory edges), with 300-400 k edges exhibiting non-zero activation during runtime. Because the architecture of the internode network system 100 does not evaluate global objectives, compute gradients, or traverse loss surfaces, it is compatible with low-power, decentralized substrates.

Utilizing the internode network system 100, short-term GPU-based implementations are combined with the development of a dedicated compute substrate where learning is expressed as physical local structure, structural change and compute scales with activity and locality, not global model size or parameter count. The internode network system 100 also scales with the amount of edges and nodes, but in the ideal case the relation between network size and physical resource is only linear as the nodes are manifested physically.

An exemplary unit of the internode network system 100 is a locally regulated node that maintains local state variables, supports short-lived traces of prior interaction, modifies local connectivity or parameters, and participates in sensor-actuator coupling. This can be only indirectly, as a node could only have intermediate nodes as input and output nodes. The unit does not need to explicitly model resource/burden flows or maintain a physical boundary. The unit or node does need to account for its viability expenditure. It tracks its own viability and how it changes, and its rules depend on this information so that the rules change as the viability changes.

### Exemplary Embodiments of an Autonomous Robot System

Now that a description of the self-building internode network system has been provided, attention can now be directed to more complex implementations and embodiments of the self-building internode network system, In some embodiments, the self-building internode network system 100 (FIG. 1) can include a more complex structure, such as a robot. It should be noted that although references will be made to an autonomous robot system, the disclosures herein regarding the robot can also apply to the self-building internode network system 100 (FIG. 1) without departing from the scope and spirit of the present technology.

An exemplary robot is communicatively coupled to a sensor, and a motor, as well as a self-building internode network system (e.g., self-building internode network system 100 of FIG. 1). The robot is further configured to interact within an environment that the robot knows or experiences only through the sensor and in which the robot produces actions through the motor, such as to create the robot's learned behaviors and memories, where the robot's learned behaviors and the robot's memories reside solely in an network topology and its specific edge strengths and transient node states of the network that are produced and driven by the robot's positive and/or negative experiences in the environment derived from the sensory processing and by viability history as well, as captured by dedicated traces.

First, the reflex-only robot is placed in an environment where its reflexes yield positive sensations more often than negative sensations. In order to learn significant new behaviors, there must be an incentive from the environment. If the original positive sensation suddenly no longer presents itself in the environment, while a yet-to-be discovered positive sensation enters into the environment, then the robot will learn behavior that systematically yields the new positive sensation. This is even the case if the robot body needs to be enhanced with new sensors to be able to recognize a new positive or negative sensation. It will integrate this new sensor on the fly, entirely automatically and based only on network activity. Entirely new network nodes and connections will be formed automatically to encode the new positive or negative behavior. The negative behavior is encoded as inhibition of the negative behavior. This is passive avoidance behavior. The robot can also learn active avoidance behavior, for example, through its dedicated avoidance-learning nodes. A network is formed which inhibits this negative behavior, such that if anything else prompts this negative behavior, it could be negated by this inhibition. The human is not required to do anything other than introduce new sensors and/or new motors or remove sensors and motors. More generally, the human's task is to modify the robot body and provide an initial network, defining, for example, its initial pleasures and displeasures, to start off its learning trajectory. Over time, those simple initial pleasures and displeasures will transform into something more complex that quickly becomes difficult to untangle for a human observer or the administrator of the network.

Calculations are not needed to be performed on a traditional computer at any time from the conception of the robot network when using a network chip. The only calculations that need to be performed are those to determine whether a network node becomes active or not, and to carry out the building operations (e.g., finding a disconnected node for node insertion), as well as keeping track of activity and viability traces. These simple calculations can be performed automatically with the use of silicon. These “calculations” happen locally, at each node.

If the new behavior that leads to strong positive and/or negative sensations are complex, requiring simultaneous network computation on many sensors, such as the nested XOR gate from before, then the reflex-only switchboard needs to be converted into a relatively complex network comprising many nodes and connections. This network readily arises in stages, but is unlikely to form at once. For example, the robot can experience incrementally positive reinforcement and negative reinforcement. The robot can first be taught a task and then distill a more complex task through negative reinforcement, which also prompts network building. If suddenly positive sensations can only be accessed when the network performs a nested XOR gate to produce motor output, then the robot is likely to start malfunctioning from the complete absence of any positive sensation. Through the avoidance-learning node, positive sensation also follows from subsiding negative sensation. If, however, the environment changes progressively, or if the environment can be influenced in order to guide the learning, then a network is likely to arise which solves the new task incrementally. For example, the environment could first require only XOR(S1,S2) in order to experience a positive sensation. Then a network will first arise that encodes this single XOR function. Analogously, the robot may learn to execute XOR(S3,S4).

Afterwards, it is relatively simple for the robot to learn XOR(XOR(S1,S2), XOR(S3,S4)), which is built upon the previous behaviors. The network building is always sequential, with simple network structures necessarily preceding more complex structures. Starting from the reflex-only switchboard, it first needs to go through a small network stage before it can reach a large network stage. Simple behaviors are first formed, which then form the basis for the formation of more complex behaviors. This results in layered behavioral complexity. The simple behaviors may then fall away, leaving only the complex behavior, or they can coexist. Any kind of network architecture can in principle arise, with, for example, feedback loops and coarse-graining features, as long as they can be constructed in a simple-to-complex manner. The algorithm will construct complex networks that can be hard to interpret for a human, and yet produce the desired behavior, in contrast with the networks of traditional AI, which generally have an overall structure that makes sense to the human operator. In contrast to the “black boxes” of generative AI, where a predefined network is chosen whose weights are then optimized, the system described herein builds its own network in stages and therefore allows for ways to interpret and analyze the connectivity architecture. The system can trace back a problem and provide a robust set of options on how to control the network at any stage. Through analysis of the network building history, often the root cause of a behavioral problem can be found. Notably, the present disclosure presents analyzable and controllable systems and methods in which the goal is for full autonomy. That being said, the present disclosure further contemplates that if essential, humans can fine-tune and hard-code parts as needed, by providing hardcoding network components that the robot cannot override as an example.

As the robot experiences the environment, the network can grow larger and larger, always ready to produce new behaviors out of existing behaviors and environmental fluctuations. In other embodiments, the network could grow smaller and smaller during some stages. Parts could also change from being mostly inhibitory to becoming excitatory.

Starting with a simple body and simple behaviors allows the organism to first learn the basic correlations that appear in the environment, which can then be built upon when the robot body is extended with more sensors and motors, when sensors and motors or their representative network nodes are enabled, or when suddenly more complex behaviors are required to experience positive sensations while avoiding negative sensations. Many complex sensors and motors can be incorporated into the body from the start, but they should be enabled progressively as the network develops and shows that it has sufficiently mastered its current set of enabled sensors and motors.

While the environment is simple, the automatic network building may produce large networks that produce rudimentary actions, but when the environment complexifies, the more complicated pathways may become crucial in allowing the AI agent (the robot in this case) to persist in encountering more positive than negative sensations, which it does by learning to chase positive sensations and avoid negative sensations. This allows the agent to progressively increase its intelligence. This way, the agent can in principle learn any task that is realizable by its sensors and motors, as long as the environment and the sensational complexity of the agent slowly change in a way that promotes the final behavior that is necessary to perform a complicated task. When a certain specimen has reached a certain level of intelligence, its network can be saved, and other specimens can be initialized with it.

### Exemplary Automatic Experience-Driven Network Construction Algorithm

As briefly touched upon earlier herein, the present disclosure includes an exemplary automatic experience-driven network construction algorithm, which is implemented in the self-building network module as described earlier herein, as well as the more primitive embodiments described later herein. The automatic experience-driven network construction algorithm can have any number of stages.

It should be noted that although the following example refers to a robot as part of an internode network system, it is within the scope and spirit of the present disclosure of the technology that the following example may be applied using solely an internode network system (e.g., internode network system 100 of FIG. 1) without a robot body.

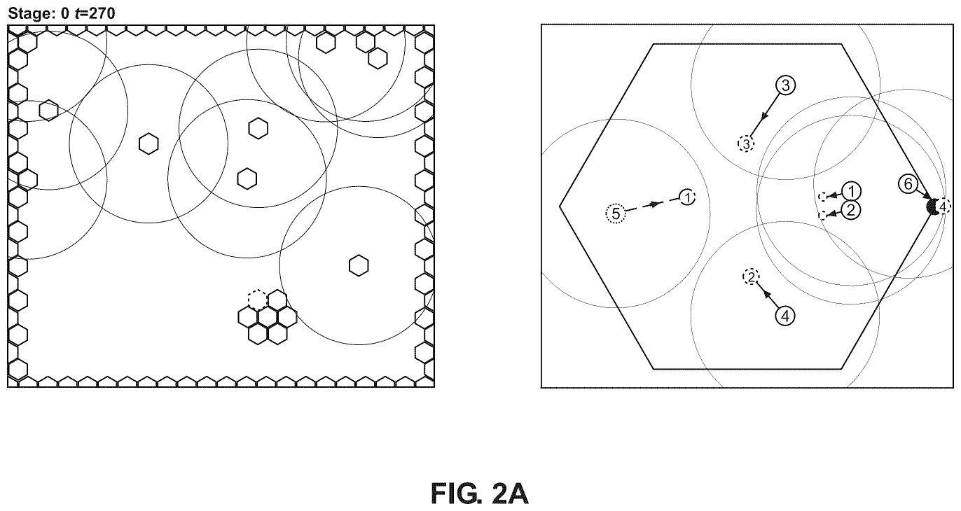

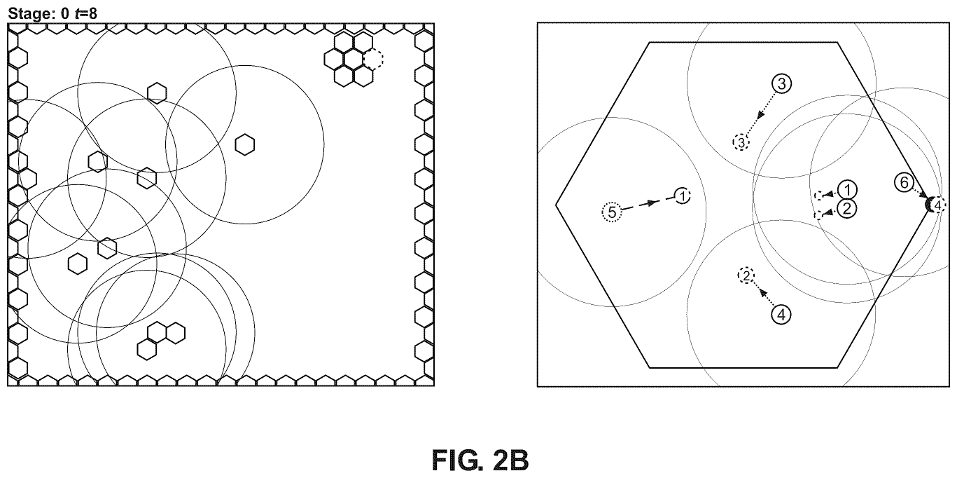

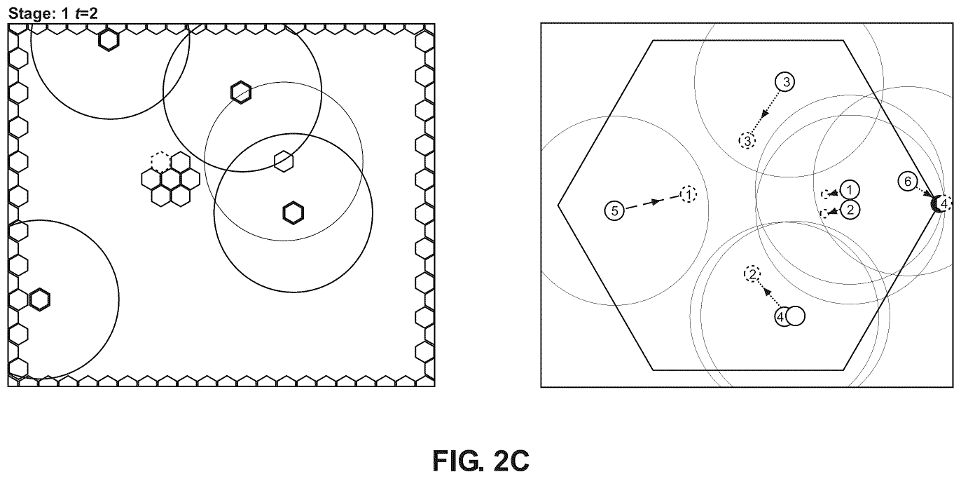

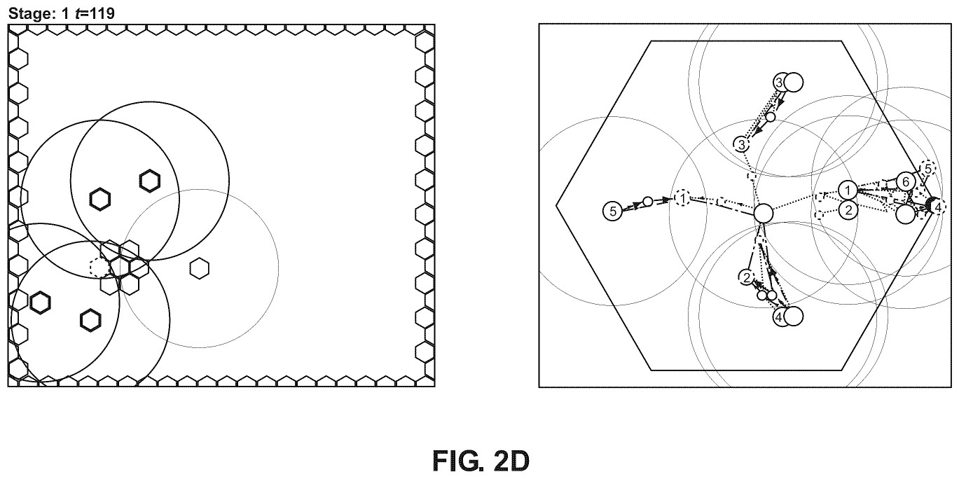

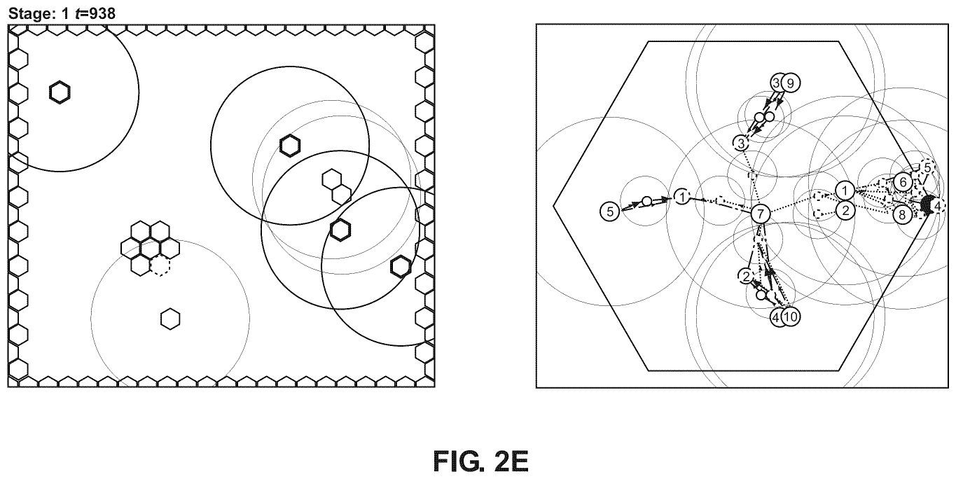

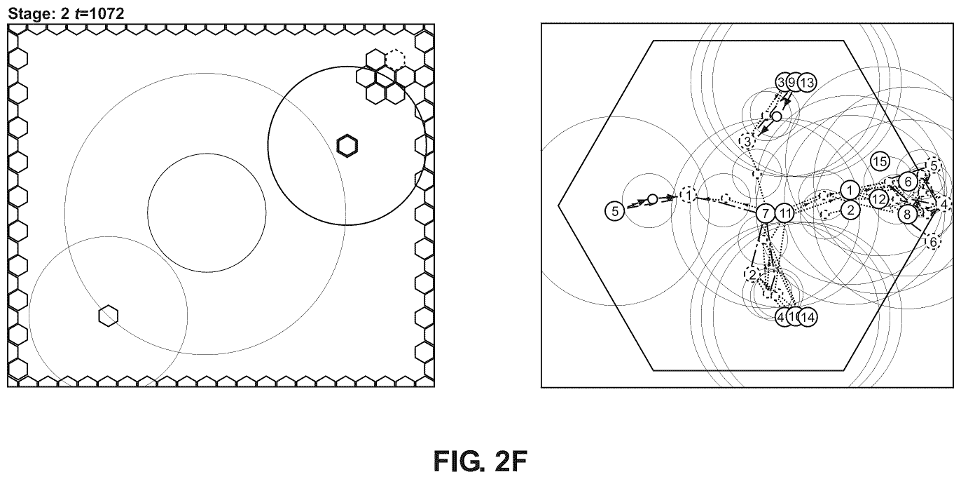

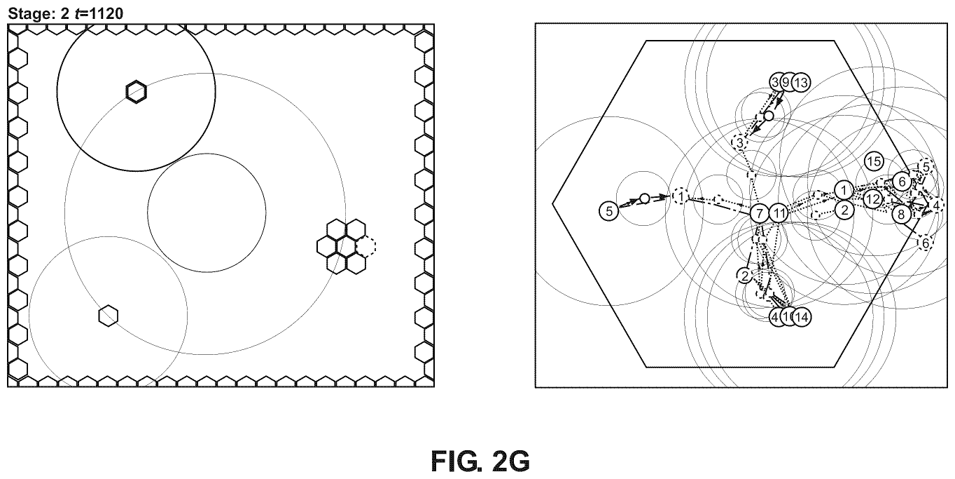

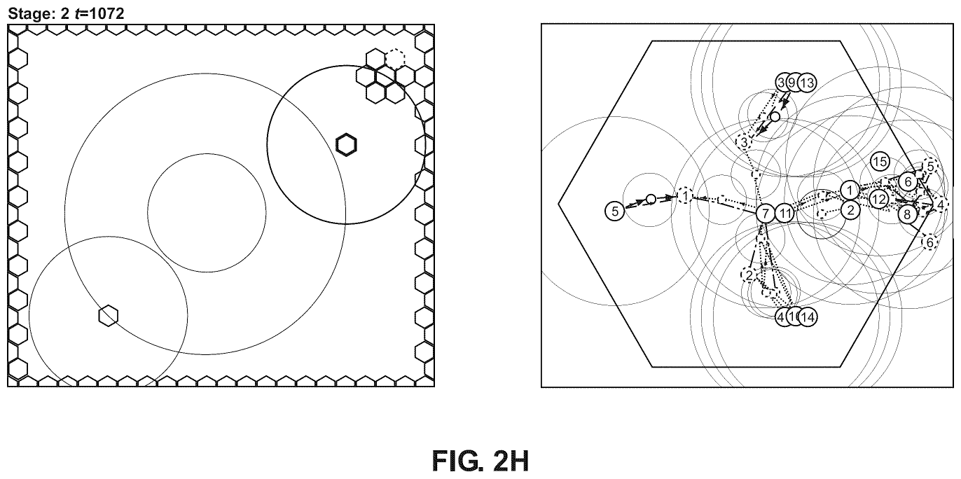

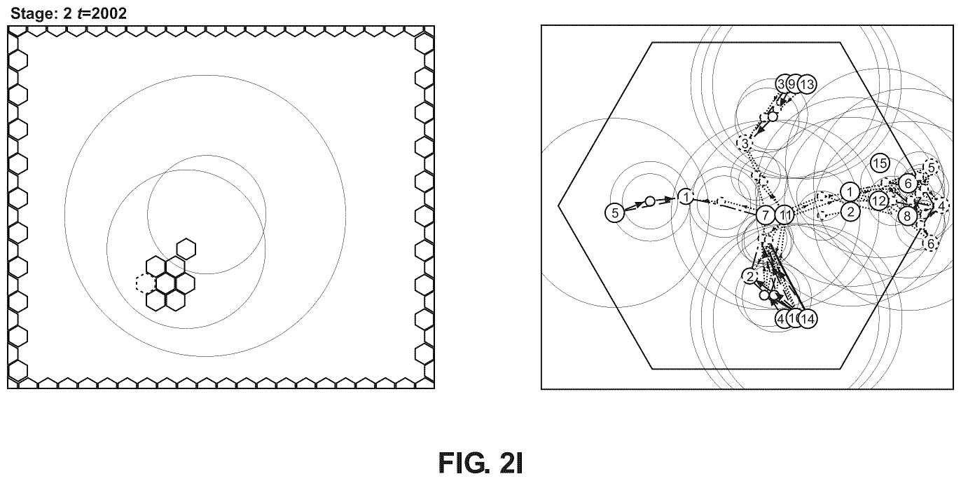

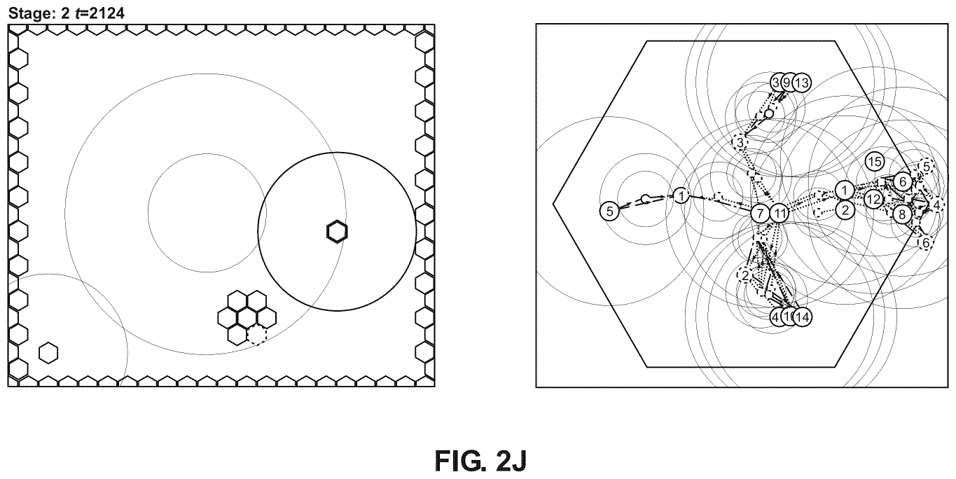

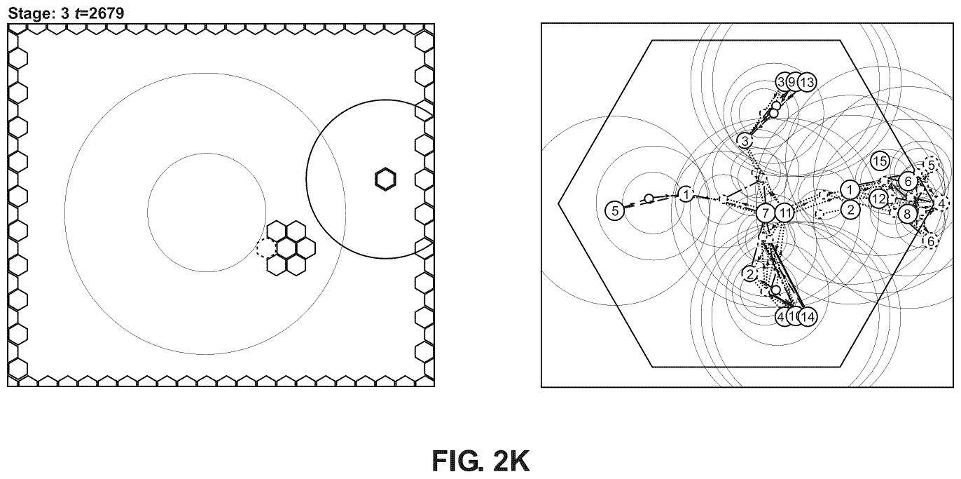

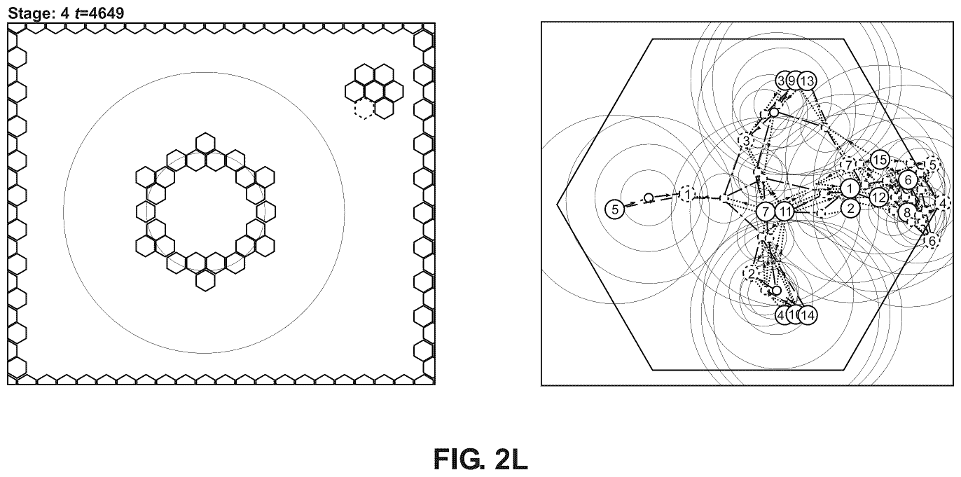

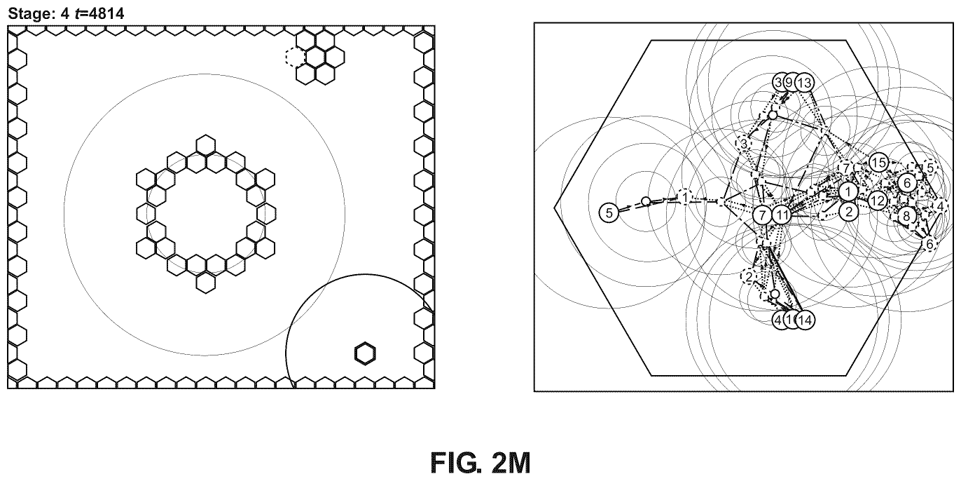

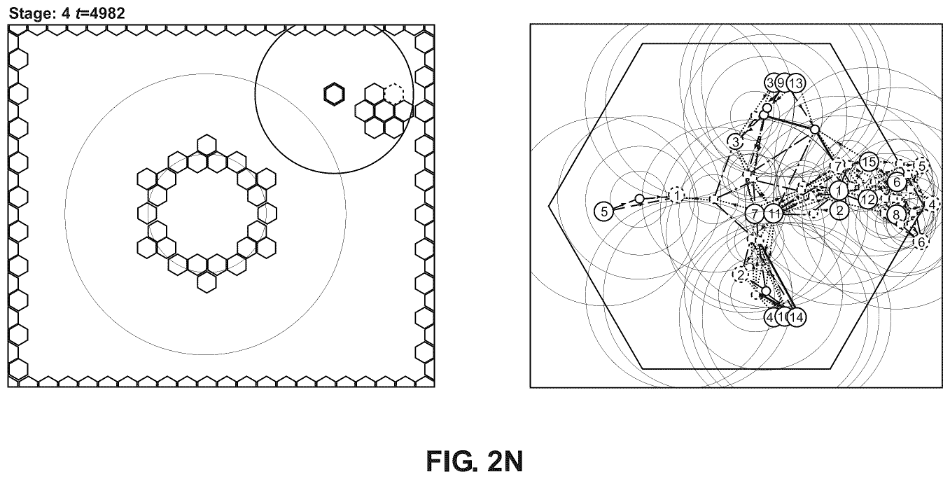

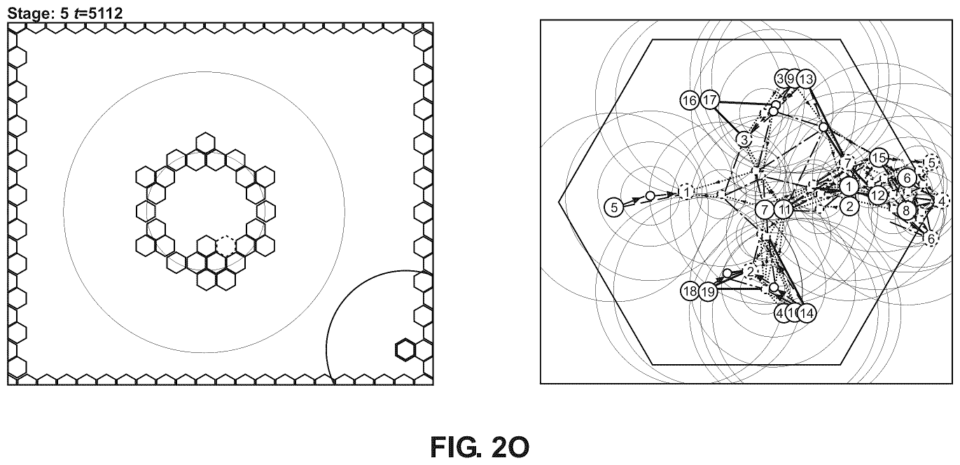

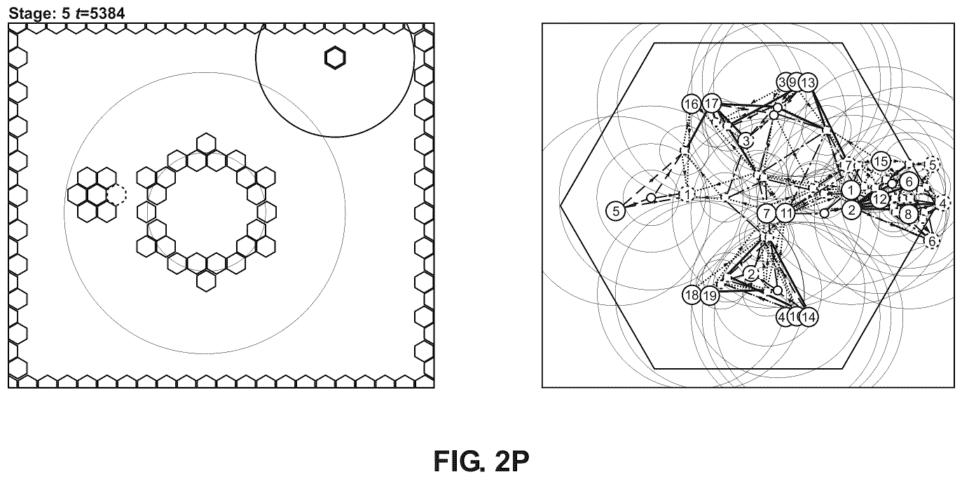

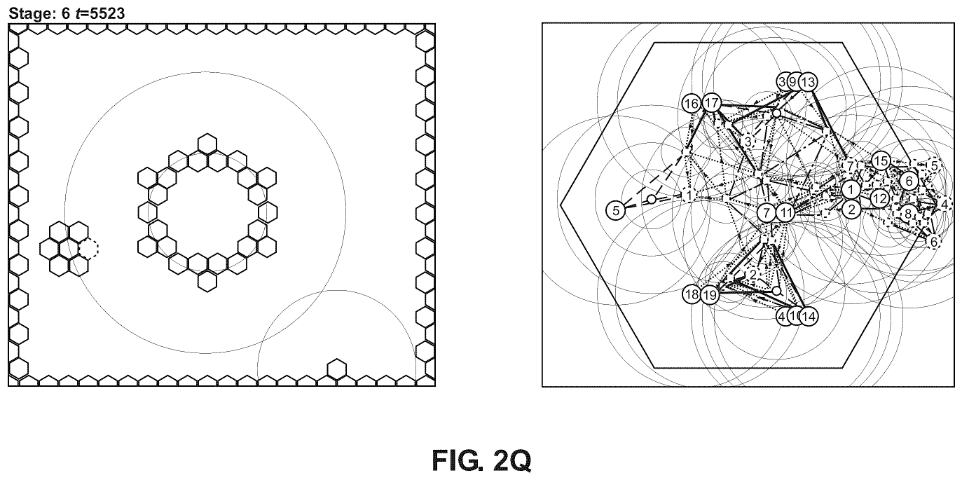

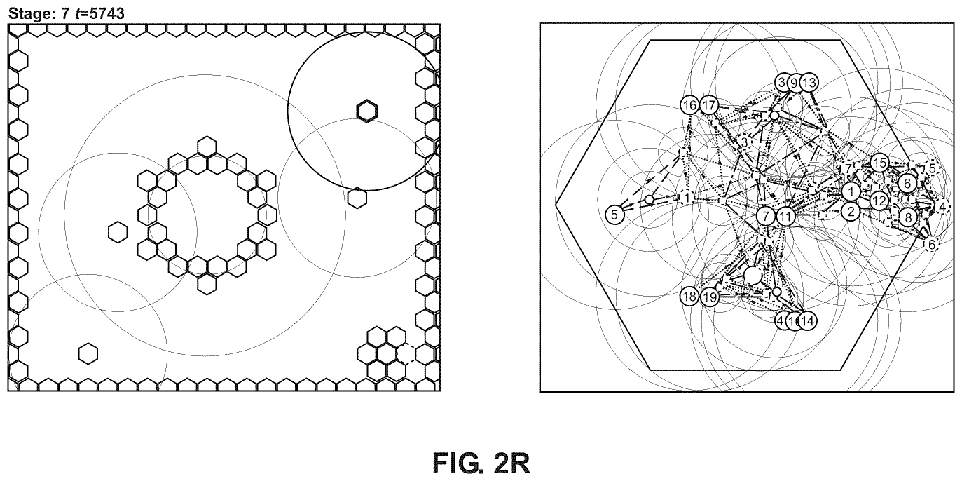

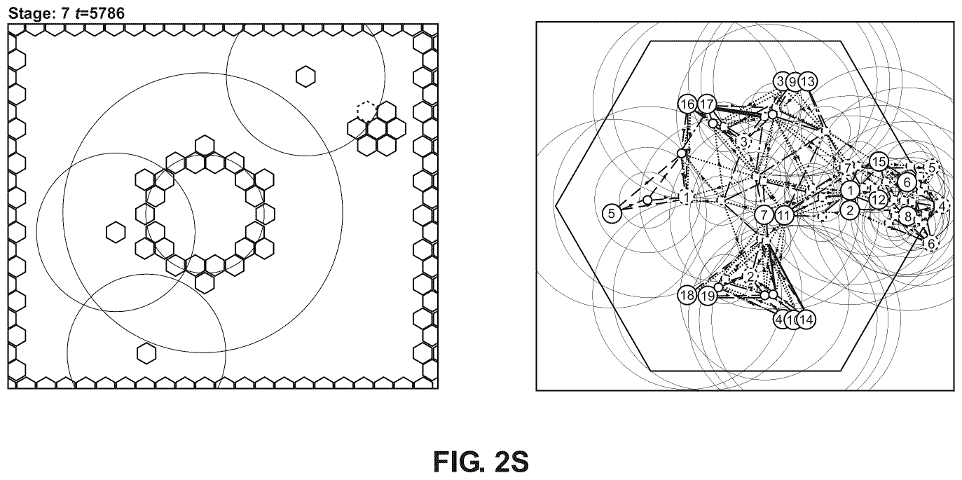

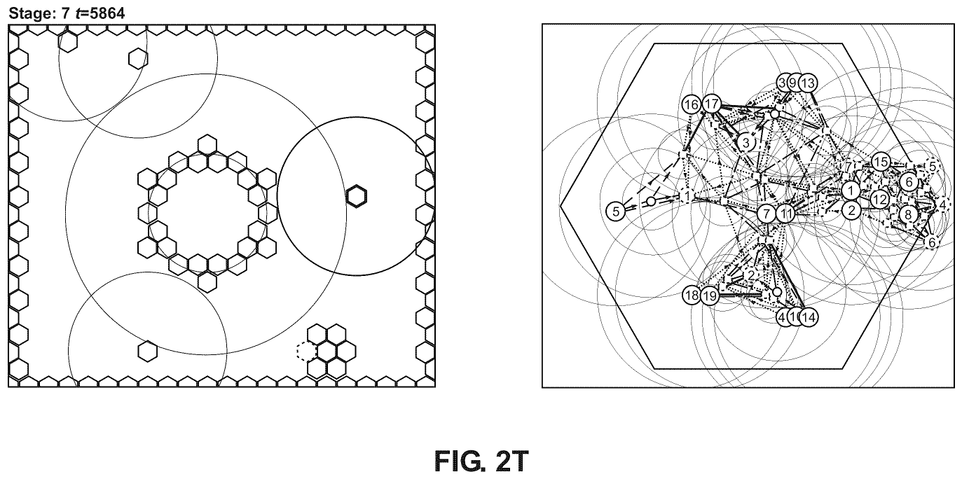

In the specific example utilizing a robot, the robot learns how to clean dust and pick up objects in order to later transfer and drop those objects to a drop zone. This example includes stages 0-7, all of which are depicted collectively in FIGS. 2A-2T. On each screenshot depicted in FIGS. 2A-2T, the left side shows the robot's movements and actions within its environment, while the right side shows the workings of a “virtual network chip” performing the algorithmic steps described in this example.

Stage: 0

Starting with FIGS. 2A and 2B, at Stage 0, the robot is initialized with reflexes that chase and clean dust and a primitive drive for cleaning dust. The robot comprises a propagation motor (1), rotation motors (2 and 3), and a cleaning motor (4). Motor nodes are numbered on the right side of the figures with solid lines and sensor nodes are numbered on the right side of the figures with dotted lines. The robot comprises a sensor that senses dust being cleaned underneath the robot body (1, turns the robot green when triggered), a sensor that senses potentially harmful energy that is being transferred to the robot body (2, turns the robot red when triggered), a left and right sight sensor (3 and 4) that detect dust from a distance within finite angles, an echo sensor that detects the presence of particles inside of the environment (5), and a sensor that senses dust under the robot body that is currently not being cleaned (6). In FIGS. 2A and 2B, the functions of reflexes are shown, without any network building, but with the constant random fluctuations of the motors that simulate the randomness of a real environment. When starting from a basic initial network, its functionality must grow in stages, with the learning of simple behavior in a simple body necessarily preceding more complicated variants. By experiencing and interacting with its environment, experiencing positive and negative consequences, the robot can learn as many tasks as its sensorimotorium allows. The term “sensorimotor” refers to the integration of sensory input (seeing, touching, feeling) with motor output (muscle movement) to facilitate bodily activity. The term “sensorimotor” encompasses both the sensor(s) and the motor(s) that were described earlier.

The robot has to accomplish this by itself, and a human can only choose an initial network and affect the environment; that is, by feeding or shocking the robot. It can be appreciated that any or all aspects of the robot's environment can be controlled by a human, or by another robot, in order to accelerate the robot's learning of desired behaviors. It is much better and faster when the environment promotes the robot's learning. After existing for some time, the robot's primitive drive changes into a highly multifaceted drive, where many kinds of experiences can lead to pain (negative experience) or pleasure (positive experience).

In this example as shown in FIGS. 2A and 2B, the lowest level of network complexity (reflexes only where no internodes can be spawned) is shown. Higher complexity is not needed for the learning that will be exhibited here, and in fact many of the behaviors can be implemented with only reflexes. The lowest level comprises purely reflexive networks, such as the one used to preset the incremental learning sequence. Network nodes can only couple with other nodes that are situated within a disk around the node. In this example, the sensor nodes are initialized with a large disk, in order to quickly be integrated into the network dynamics, but the internodes are initialized without a disk, which instead appears and grows over time. It grows whenever a node can engage in building but has no others within its range, and it shrinks whenever it is actively building. This is one of many approaches. It should be noted that this is only one way of ensuring slow network growth. For example, one can select a random subset of nodes (that changes every now and then), instead of requiring them to be within a certain distance.

This prevents explosive network building. In contrast, in FIG. 2D, there are new internodes between sensors and motors, and no new internodes between internodes, so it exhibits the second level of network complexity. The second-to-lowest cap is where one internode can in principle be spawned for each sensor, motor pair that are within reach. The cap can be increased further by allowing nodes to be spawned between “layer 1” internodes, i.e. those that were spawned between a sensor and motor, and so on. This is how the built network is explicitly layered.

The positions of the sensor and motor nodes can be chosen arbitrarily and can be changed during the life of a robot. However, the specific choice of positions affects the learning speed and quality of a robot, because each network node first considers its neighborhood when making new connections (especially the internodes). A suitable arrangement can therefore greatly enhance the learning, although many different arrangements will eventually converge on a similar set of behaviors. It comes down to the design of the mapping of the robot body to a layout of sensor and motor nodes.

Stage: 1

The incremental learning sequence begins in Stage 1, shown in FIGS. 2C, 2D, and 2E. The environment is reset, and the network building feature is activated. This network building, which is entirely automatic and requires no optimization calculations, is guided by incrementally changing the environment and the sensorimotorium of the robot. When starting from a basic initial network, the robot's functionality must grow in stages, with the learning of simple behavior in a simple body necessarily preceding more complicated variants. Objects (which are depicted as particles on the left side with darker solid lines in FIGS. 2C, 2D, and 2E) are added to the environment and the robot is expanded to have an arm motor (5) that can grab and hold objects for a fixed duration, after which the robot drops the object. A sensor is added to the robot that senses objects when they are adjacent to the robot head (8), as well as sight sensors that sense objects within a certain radius and angle (9 and 10), and a motor sensor that senses when an object is currently being grabbed (7).

The magnitudes of the sensor signals depend on the intensity that is being sensed, which is usually determined by the amount of sensed entities and their individual intensities. Hence, if many objects are within the robot's visual field, and most of these objects are very bright, then the robot's sensor will fire relatively strongly. Dust particles are hidden under the objects, and a dust particle is revealed when the robot grabs an object. The robot learns to grab and move around objects, being motivated primarily by the hidden dust. After the robot has learned this, which happens relatively quickly because the initial network is chosen to be relatively weak, the robot can perform this behavior for some time, until it becomes embedded to the extent that the sensation of grabbing by itself has come to motivate the robot. This motivation is due to the strong association between grabbing an object and the cleaning of the dust that is hidden underneath the object, which is the primitive drive. This way, through network building, the primitive drive goes from a singular drive to a double-faceted drive, since now both dust cleaning and object grabbing are motivating the robot.

Stage: 2

In this example, viability aspects are not yet enabled, as shown in FIGS. 2F, 2G, 2H, 2I, and 2J, the robot is now motivated by both dust cleaning and object grabbing, with the power of each being determined by the specific network configuration that has been built. Although it is conceivable that dust particles could be omitted altogether, and objects only could be used to reward the robot, in this example, it is useful to keep the dust particles around, because this generates motor activity that can be coupled to the activity of new sensors. In this way, motor responses can be transferred from one sensation onto another. A drop motor (6) can be added and prevent the automatic drop after a fixed duration. In the middle of the environment, a drop zone can be implemented, to allow for the robot to learn to drop objects into the drop zone. Whenever an object is dropped into the drop zone, a new object is spawned right behind the robot, to incentivize the robot's act of dropping the object into the drop zone. The drop zone is depicted as a circular disk on the left side of the figures, the circular disk having a lighter line stroke in the center of a bigger circular disk. The drop zone emits light that can be detected by a new set of sight sensors (13 and 14) of the robot, within a finite radius and within a specific angle for each sight sensor, that is depicted as a light blue disk. A new sensor that detects whenever the robot head is inside the drop zone (12) can be added, and also a motor sensor can be added that detects whenever an object is being dropped (11). The robot learns to chase the drop zone and drop objects into it. Because an object is dropped in front of the robot head, the robot only needs to come up with its head to the edge of the drop zone before dropping.

Stage: 3

At this point, as shown in FIG. 2K, spawning dust is stopped and the robot is allowed to perform the act of dropping objects into the drop zone for some time. Afterwards, the act of dropping objects into the drop zone has also become a significant part of its motivation. This means that the pleasure node has acquired new incoming connections. The neuromodulator nodes are not shown in the network diagram of this example.

At that point, there is no need to reward this behavior with objects, so in the next stage we will spawn a new object somewhere randomly whenever a successful drop of an object by the robot occurs.

Stage: 4

At this stage, as shown in FIGS. 2L, 2M, and 2N, and in this example, a wall of immovable but small-height objects is added around the drop zone. Further, a lift motor (7) is added to the robot, which elevates the robot body such that the robot can move over such objects. A new sensor is added to the robot, which is a sensor that detects immovable objects adjacent to the head (15). The robot learns to move over the immovable objects because this consistently allows the robot to drop an object into the drop zone.

Stage: 5

To streamline the robot behavior, it is desirable for the robot to stop approaching towards or chasing the drop zone whenever it is not carrying an object. In order to accomplish this, as shown in FIGS. 2O and 2P, the sensorimotorium must be expanded, equipping the robot's body with sensors that detect whether the robot is holding an object and its weight (16 and 18), and also conjugate sensors that detect if no object is being held (17 and 19). The zone-chasing-while-not-holding behavior is negatively reinforced by shocking the robot whenever the robot is performing this behavior. After some time, the behavior is inhibited. Because the drop zone is often present during positive events, which can come from multiple types of sensory experiences, the chasing without carrying behavior quickly comes back due to the strengthening of the excitative network connections that constitute the bare chase-drop-zone behavior, but now it can be rapidly inhibited again with only a few shocks to the robot, since the inhibitive connections have already been established previously. The absence of positive sensations for a certain amount of time is registered as a negative sensation, in order to automatically break down pathological network elements. The absence of negative sensations for a certain amount of time after the occurrence of a negative sensation is registered as a positive sensation, to allow for active avoidance learning. All of this is orchestrated by dedicated neuromodulator-only nodes.

Stages: 6 and 7

Stages 6 and 7 of this example are shown in FIGS. 2Q, 2R, 2S, and 2T. Dust particles can be added to show that the robot can now do all tasks at the same time: chase and clean dust, and chase and grab objects in order to chase and drop into the drop zone. After the incremental learning routine, in this example, the robot's body has expanded from six to nineteen sensors and from four to seven motors. Through the incremental routine, the robot has moreover learned to use all of these components together, with the basic behaviors from the initial stages forming the foundation for the more complex behavior of the later stages. At the end, cleaning dust, grabbing objects, and dropping objects into the drop zone have all become part of the robot's internal motivation. All of these can now be used to guide the robot's learning.

By further expanding the body, this multifaceted motivation can continue evolving, with new motivations arising and potentially old ones being forgotten. These can become increasingly distantly related to the initial robot's primitive drive of wanting to clean dust, although this primitive drive is usually strong such that it will form a significant part of the motivation even if it already consists of many components. The incremental learning procedure is finished for now, and the automatically built network is saved to use it later as an initial network for a more advanced incremental learning routine.

It should be noted that, at any moment, the developed network can be saved and loaded onto other robots equipped with sensorimotor configurations. For direct transfer of a network from a sending body to a receiving body, the receiving body sensorimotorium needs to have the sensorimotorium of the sending body as a subset. This particular process can be accomplished at any stage of the algorithm. These upgraded robots having uploaded networks will immediately perform independently from that point, leveraging the existing background knowledge, without needing to relearn. This is an essential advantage for scalability. This system can scale smoothly because it learns incrementally, step by step. The robot first learns basic behaviors before handling more complex tasks—real-world scalability works the same way. One would not expect a robot to immediately walk and sort objects simultaneously. The robot first needs to master simpler tasks like moving or avoiding obstacles, or with an eye on viability, the robot first needs to learn even more basic behavior such as energy and heat regulation of its body. Here, cooling motors and battery are crucial. By gradually adding complexity to the environment, along with new sensors and motors, the robot seamlessly builds upon previously learned behaviors, eventually handling sophisticated tasks and extensive sensor arrays effortlessly. For the transfer of learned behaviors to another machine, they do not need to be identical, but for direct transfer the receiving body needs to have the sending body as a subset. The learning of a very simple body can be used to initialize a more complex body, as long as the complex body has all the simple sensors and motors. In the case that it does not have the simple sensorimotorium as a subset, the corresponding nodes and their connections can be omitted when transferring the network, but this could affect the behavior in unforeseen ways. This also applies when transferring from a more complex to a simpler robot. With a direct transfer the behavior is most likely to find a sensible manifestation in the new body. Each robot network builds on its own after that point, so that if their respective environments start differing, the networks will eventually become vastly different. Even if the environments are the same, due to internal random fluctuations the learning will be slightly different, which ultimately amounts to vast differences, akin to the personalities of individuals. Also, in some embodiments, the behavior transfer includes initializing a complex robot with behaviors learned by a simpler robot, such as navigation skills from a vacuum robot applied to a humanoid robot or to a car.

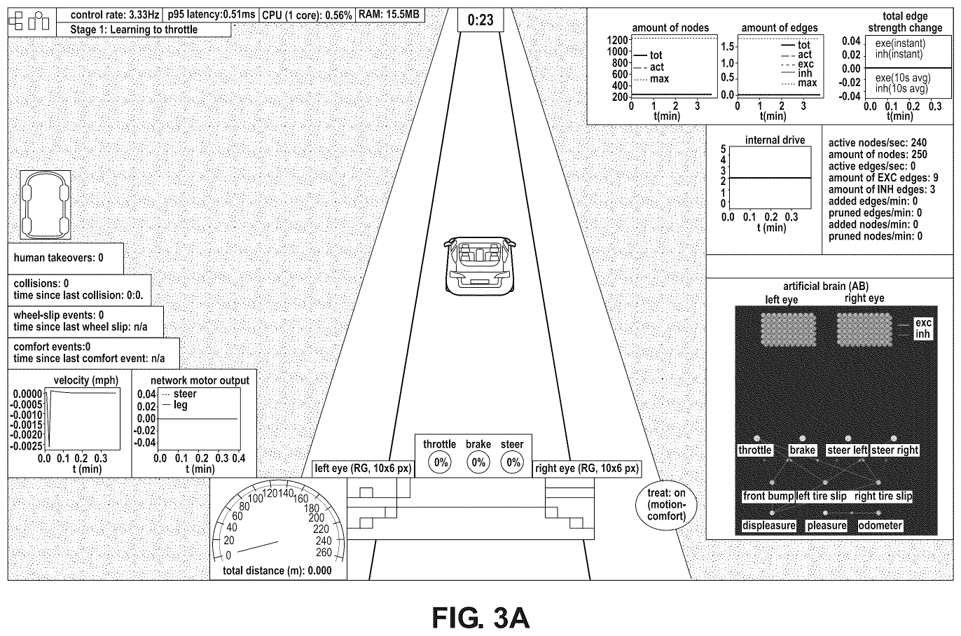

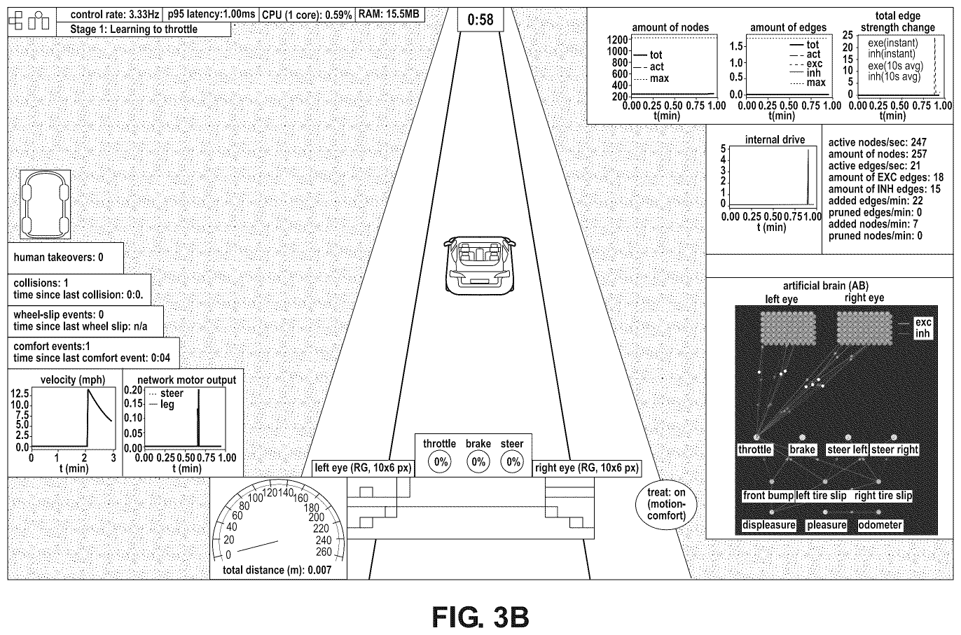

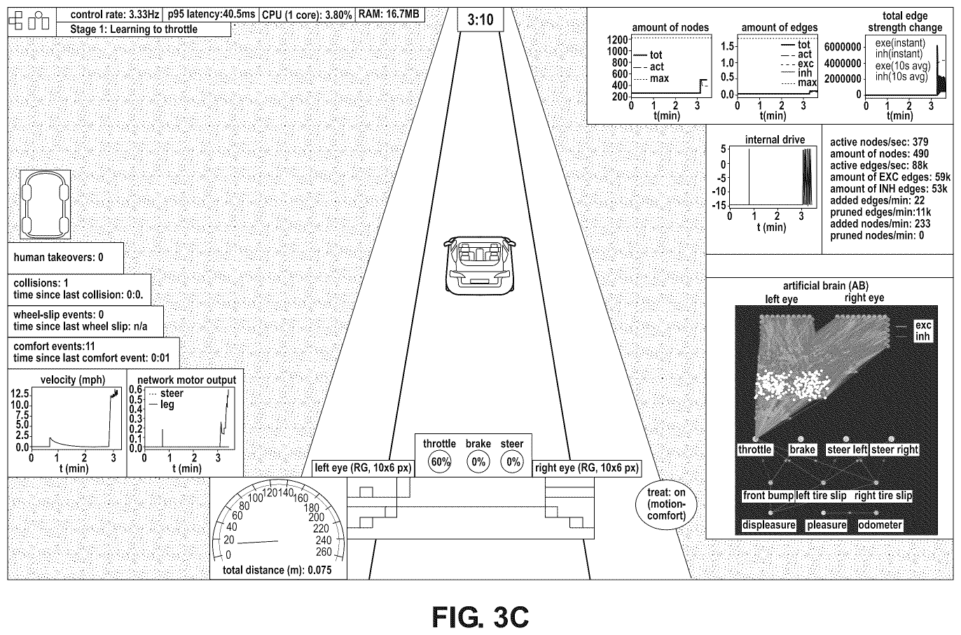

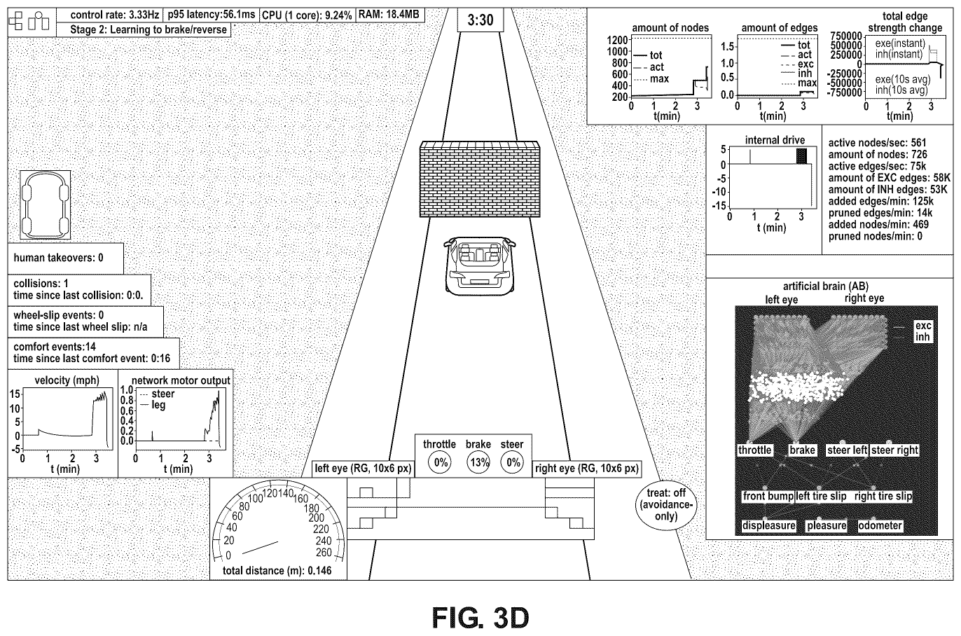

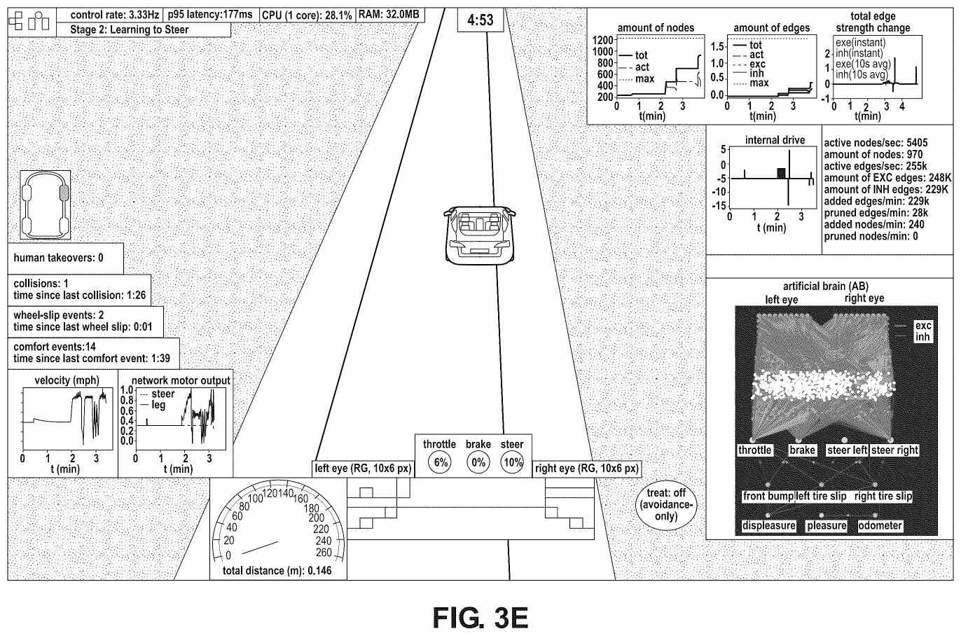

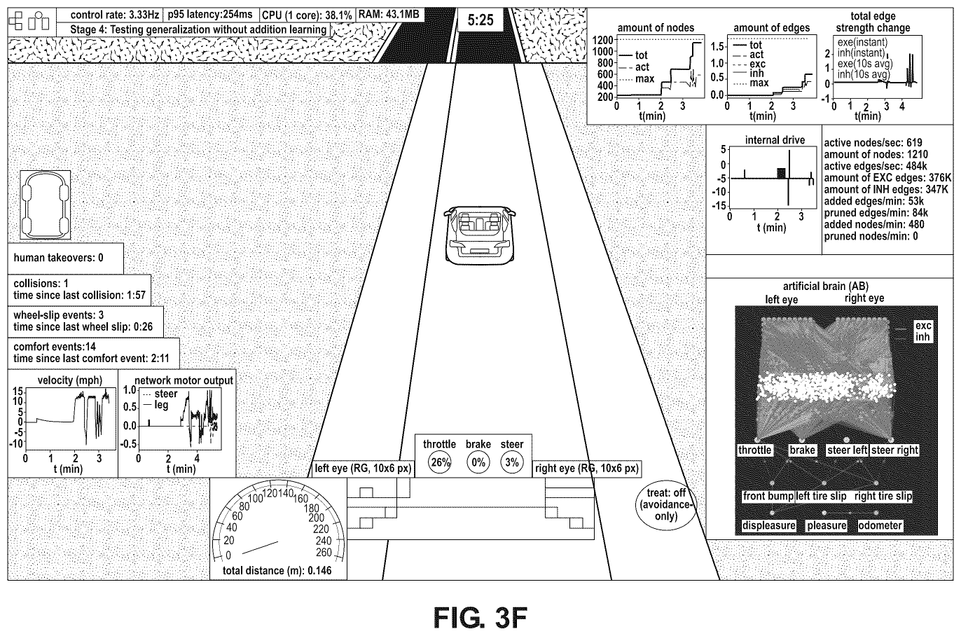

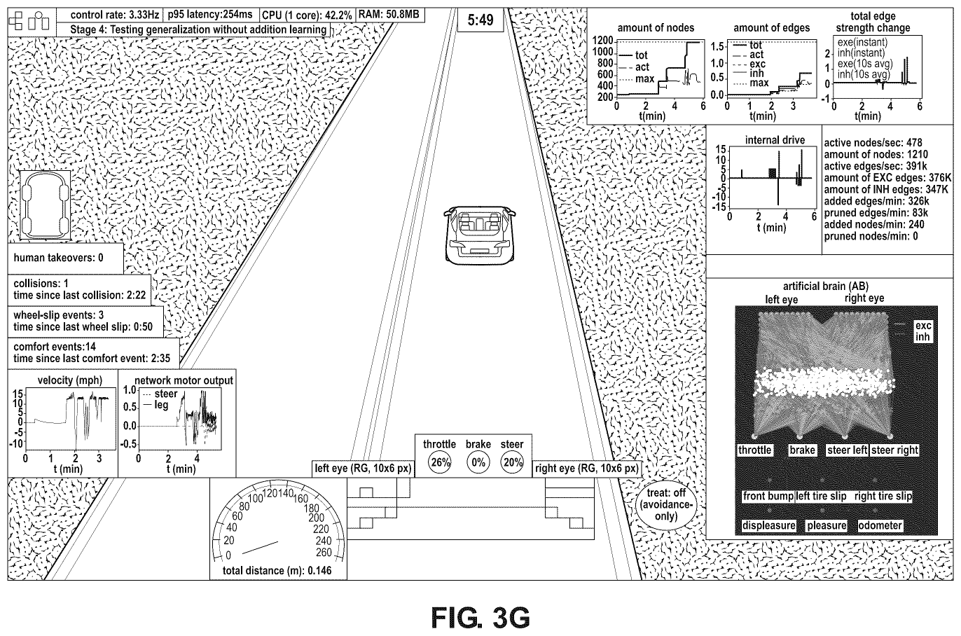

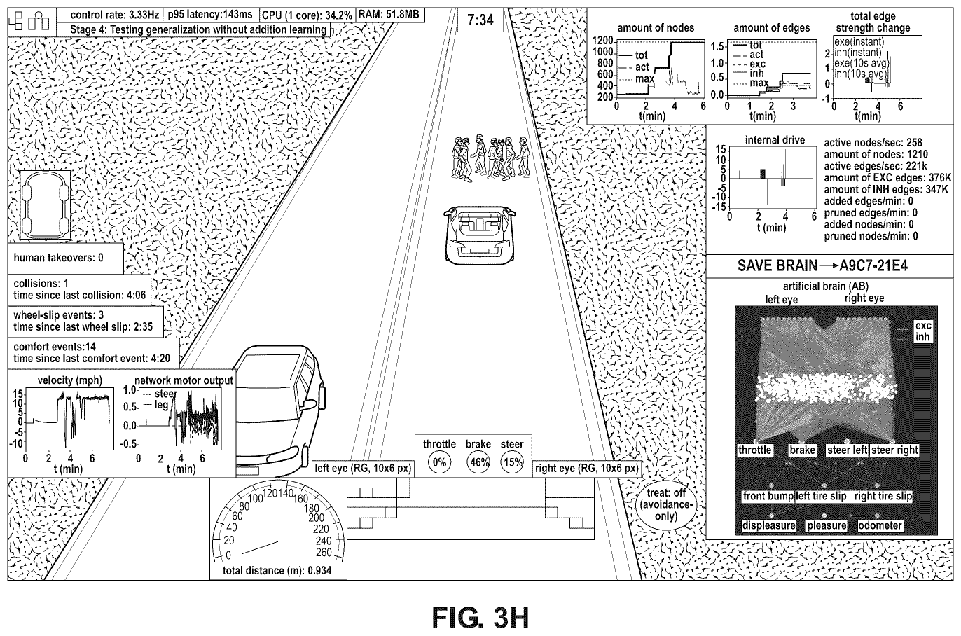

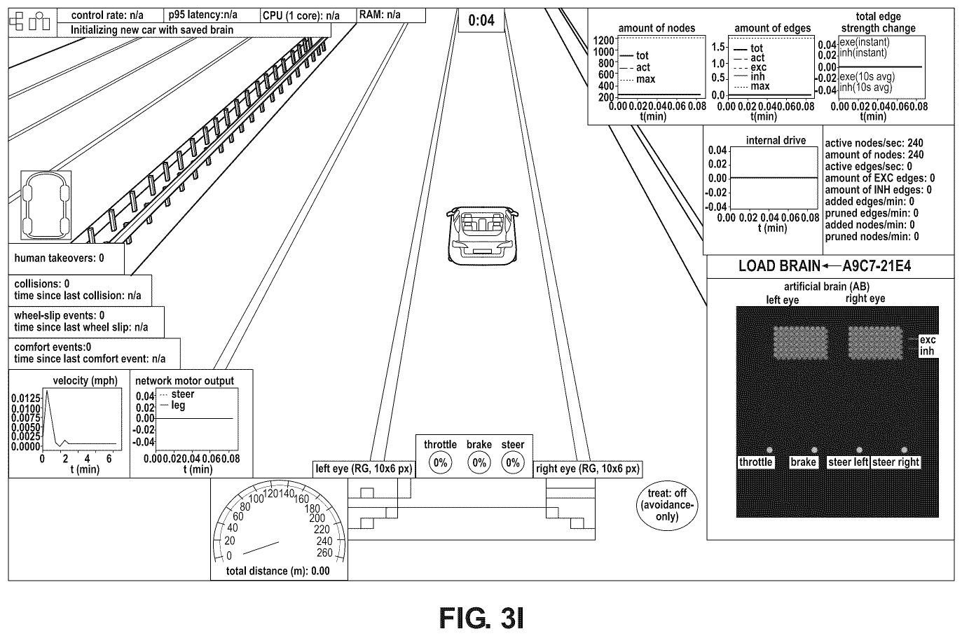

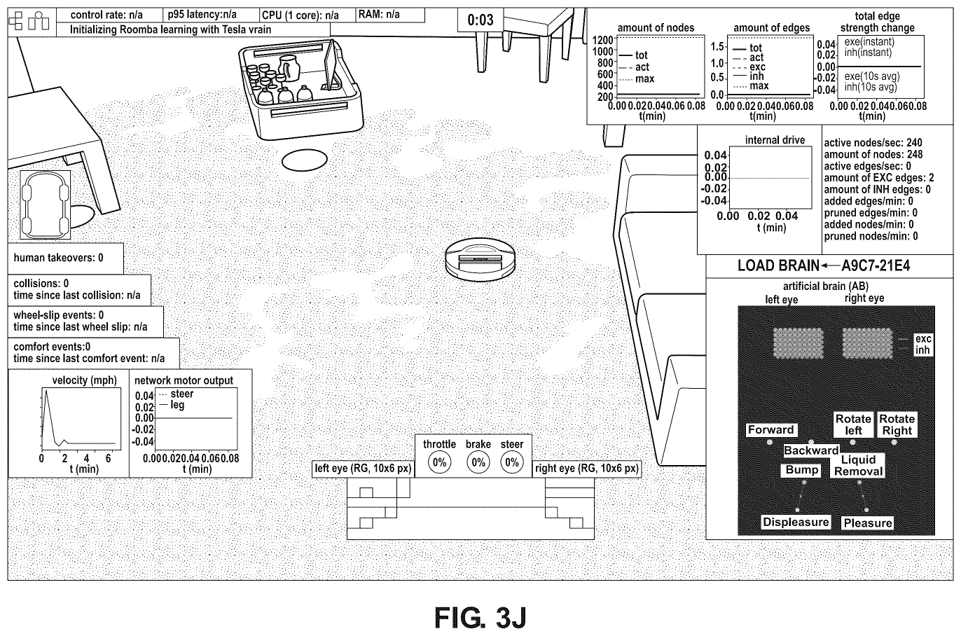

FIGS. 3A-3J are screenshots of exemplary embodiments of a self-building internode network system. Specifically, FIGS. 3A-3J depict a car learning navigational skills based on the self-building internode network system and later, a robotic vacuum performing a similar activity as well as a car in a vastly different environment. Specifically, FIGS. 3A-3I depict a demonstration of a car learning how to navigate a road, without any previous training, and ultimately resulting in a transferrable robot “artificial brain” that is based on the self-building internode network system. As shown, FIGS. 3A-3I show how a network forms with nodes and connections, within minutes, with very little compute, and without human intervention. The network build is local and event-driven, and without relying on replay or a data set. There are four motor nodes in the network, namely, throttle, brake, steer right and steer left. FIGS. 3A-3I also show the body of the car, eyes, four primitive sensors, an odometer for motion, and hardwired reflex links used for kickstarting learning. Finally, FIGS. 3A-3I also show internal drive nodes for pleasure and displeasure which emit tiny automatic reflex like pulses tied to the robot's motion. The robot car learns what matters from experience. The robot learns that driving is pleasurable, and also the robot's crash into an obstacle (e.g., a brick wall) is a learning experience. Ultimately, the robotic car learns on its own and forms its own network (its “artificial brain”), in order to drive smoothly and without incident, even when people are walking across the road.

Once the robot car's brain is developed, then its brain can be saved and transferred to another robotic car, or even to a robotic vacuum as shown in FIG. 3J. As shown in FIG. 3J, the vacuum robot avoids furniture, and it also learns a new skill of collecting green slime on the floor in its environment. The new skill is developed thanks to edge plasticity. This impressively all occurs using limited computation resources, namely, one CPU, 50 megabytes, and using zero datasets. When transferred to a car in a vastly different environment, it reapplies its learned behavior to the new environment and manages to drive within its lane and avoid a traffic accident. Both the behavior of the robotic vacuum and the car in the other environment required no additional learning.

### Exemplary Embodiments of Methods Utilizing an Automatic Experience-Driven Network Construction Algorithm

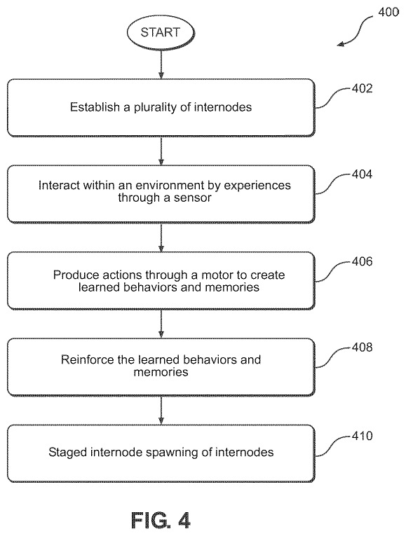

The present disclosure has described earlier both the self-building internode network system and the automatic experience-driven network construction algorithm. Turning now to FIG. 4, FIG. 4 is a flowchart illustrating a method 400 utilizing the automatic experience-driven network construction algorithm, according to an exemplary embodiment.

At step 402, the method 400 begins with establishing a plurality of internodes of a system. The plurality of internodes includes both input nodes and output nodes. In some embodiments, an internode is a node that has synaptic and/or neuromodulator input and output channels. In other embodiments, an internode can be a node, an edge, or any combination thereof. One or more motor(s) and one or more sensor(s) can be communicatively coupled with the plurality of internodes. In some embodiments, the method allows for the formation of an internode network system by coupling the motor, the one or more sensors and the plurality of internodes with a self-building network module that is configured to implement an automatic experience-driven network construction algorithm to build the network system. The formation of the internode network system and the reflex-first learning may be incremental. This reflex-first learning applies only when a basic network initialization is used. If many intermediate internodes already appear in the initialization, it does not start from reflexes but from something that is already a bit more complex, although likely less complex than what will be spawned from it by the building operations.

At step 404, interactions occur within an environment by experiences. In some embodiments, the interactions that occur within the environment can be said to be experienced through neuromodulator node activity and sensed through one or more sensors. Such experiences may be positive experiences and/or negative experiences. This relates directly to how these experiences, and the associated neuromodulators in particular, relate to the node operations that they induce.

In some embodiments, the viability history of a node affects the way in which it operates, for example affecting the way in which it directs its structural adaptation operations such as edge and node insertion.

In some embodiments, the system can acquire and refine complex behaviors through environmental interaction alone. Simple reflexive behaviors must first yield positive experiences and/or negative experiences (and optionally also affect the local viabilities in certain ways) before a complex, adaptive structure emerges to govern motor outputs.

As discussed earlier, an adaptive threshold controller adjusts each node's activation threshold to stabilize network growth as complexity increases. Further, adaptive threshold scaling can be performed based on total incoming network edge strengths. Often, this is the only kind of network-activity-stabilizing threshold adaptation that occurs, although, in principle, more could be used. The threshold is also modified based on the viability state of a node. Thus, no external memory or central control unit is required, since the internode network system's learned behaviors and its “memories” can reside solely in the network topology, the strengths of its connections, and the transient node states. This fully decentralized on-board learning and adaptation capability enables the internode network system to acquire and refine complex behaviors through environmental interaction alone.

As stated earlier herein, the internode network system achieves experience-driven learning organically through local properties, such as connection strengths and node activation thresholds, and global properties, such as network topology. More specifically, the present disclosure concerns an internode network system that embodies decentralized adaptive learning without reliance on traditional centralized processors, external memory, and/or floating-point computation.

Returning to the method 400, at step 406, actions are produced by the system through the one or more motor(s) to create learned behaviors and memories. At step 408, the learned behaviors and memories of the system are created based on neuromodulator node activity, sensory processing of the one or more sensors, network activity based on activity of the plurality of internodes, viability history, and reflex-first learning that expands into higher-order structure. At step 410, staged internode spawning of the internodes occurs. In some embodiments, the staged internode spawning of the internodes is based on causal firing activity between the plurality of internodes. In other embodiments, the staged internode spawning of the internodes is based on local activity traces, causal activity relationships, co-activation history, or other locally available interaction-derived signals.

In some embodiments, step 410 is a part of step 408, insofar that learning occurs through the network operations, in general, including but not limited to edge insertion, edge deletion, and edge modification.

The adaptive threshold determines how much input a node needs in order to fire, which in turn determines the activity traces, which in turn (together with neuromodulators and viability information) are used to insert specific nodes and edges into the internode network system, as well as to modify existing edges, and also to delete edges and nodes.

The method 400 can also include an optional step that as the internode network system interacts with its environment, the network activity both generates internal reinforcement signals and autonomously instantiates new internodes and edges, incrementally forming the higher-order processing structures.

The method 400 can include an optional step of implementing decentralized adaptive learning. Due to decentralized adaptive learning, no external memory or central control unit is required, since the internode network system's learned behaviors and its “memories” can reside solely in the network topology, the strengths of its connections, and the transient node states. This fully decentralized on-board learning and adaptation capability enables the internode network system to acquire and refine complex behaviors through environmental interaction alone.

This internode network system achieves experience-driven learning organically through local properties, such as connection strengths and node activation thresholds, and global properties, such as network topology. More specifically, the present disclosure concerns an internode network system that embodies decentralized adaptive learning without reliance on traditional centralized processors, external memory, and/or floating-point operations. The method 400 can also include an optional step where the building, rebuilding, or formation of the internode network system may be selectively paused, re-started, or re-enabled at any time. In other words, the formation of the internode network system can be stopped and then continued one or more times, without any adverse effect.

The method 400 can optionally include a step of adding or enabling one or more input nodes. The method 400 can optionally include a step of adding or enabling one or more output nodes.

In certain embodiments, the adding or enabling of the one or more nodes (whether they be input nodes and/or output nodes) occurs at or nearby a spawned internode. It should be noted that input nodes and output nodes are not spawned in the same way as intermediate nodes are autonomously spawned. In some embodiments, input and output nodes are inserted by a human or an administrator, and assigned a location and a sensor or motor entity to which it couples.

### Exemplary Embodiments of a More Primitive Architecture and a Bounded Computational Local Unit

As described earlier herein, the present disclosure further includes a more primitive architectural embodiment having a substrate in which each local unit is itself more body-like (or cell-like). This more primitive embodiment is characterized by its boundary-based and internal-based viability regulation, based on boundary-level and internal-level rules.

As mentioned briefly, the local unit of this more primitive embodiment has an inside, an outside, a boundary, usable resource, spent burden (more generally, viability variables), and local ways of affecting the medium around it and being affected by it, the nature of which can depend on the viability history of the unit. This embodiment is not just a graph network of nodes and edges, but rather one or more bounded local viability-bearing processes occupying a medium that is coupled to the environment through a medium-environment boundary, that begins to shape their own structure through interaction with the medium. With this embodiment, the local units themselves become more explicitly viability-bearing, body-medium-coupled, consequence-resolving, and capable of local structural specialization through lived resource/burden dynamics.

In other words, this more primitive embodiment is that of a more primitive class of units and substrates from which the more complex systems such as the graph formulation can arise. A membrane-bounded computational unit having a membrane as a boundary is one embodiment of this more primitive architecture, which will be described in greater detail later herein.

The word “boundary” as used herein is a locally regulated boundary through which a resource, burden, force, signal, or state can be exchanged, sensed, restricted, amplified, damped, or structurally adapted. Examples of a boundary include, but are not limited to: membrane boundaries, physical or virtual boundaries between an interior state and an exterior medium, interface boundaries between two units, sensorimotor boundary regions, exchange boundaries regulating resource/burden flow, soft-body/skin-like boundaries, structural frame boundaries or load-bearing interfaces, docking/coupling interfaces, actuator-facing or motor-facing boundary regions, and software-defined or substrate-defined boundaries in a computational medium. The structure inside of the boundary, namely the internal unit, can also adapt, based on external influences that are transferred by the medium.

Referring still to the more primitive embodiment, this embodiment utilizes a substrate having one or more local units. Each local unit has an interior, an exterior, and an interface through which exchange occurs. The interface can be a boundary that is made of a plurality of boundary segments. The local unit further includes one or more viability variables. The viability variable(s) of the local unit determines its state, as per the four-state grammar that was outlined earlier. The boundary segments of the local unit are adaptable based on the unit's state history and local physical residues within the local unit. The plurality of viability functions is configured to directly govern operations of the computational local unit. Higher-level network-like behavior of the computational unit emerges from boundary-level rules that use the plurality of viability variables.

The unit-level rules that govern the instantaneous and structural response of the unit's parts are rules that are dependent on the viability history of the local unit. As an example, in state 1, where energy is above viability and the unit is moving away from viability, the unit wants to let in less resource and let out less waste. This causes the local burden to increase while it decreases the energy generation, such that its viability will likely increase less rapidly and potentially start moving downwards back towards the viable range. If it is above viability but moving back towards viability, it will still want to close its boundary or membrane but less than when it was moving away from viability. Similarly, in states 3 and 4 below viability, it opens the membrane. Crucially, each part of the membrane has a separate set of opening and closing “actuators”, which leave behind a physical residue. If the viability situation of the unit is improving, these physical residues will be used to make one type of structural adaptation, while if the situation is worsening, it will make an opposite type of adaptation. Over time some part of the membrane might become permanently biased to open while another part might become permanently biased to close, depending on the flow that passed along there and the resulting apparent effect on the viability state.

Hence, it can be said that the more primitive architectural embodiment is based on boundary-based viability regulation. Such boundary-based viability regulation utilizes antagonistic local boundary operations. In a non-exhaustive list, such antagonistic local boundary operations include the opening/closing, intake/discharge, and amplification/damping of the boundary or boundary segments.

Also, as mentioned earlier, the primitive architectural embodiment utilizes local residues or activity traces as the basis for making one or more structural adaptations of the local unit. The primitive architectural embodiment is also characterized by a conversion of local consequence based on signals and viability states, into a persistent structural change of the unit and/or the unit's boundary or membrane. That is, over time, if the unit has a membrane, some of the membrane segments may become permanently biased to open, while other membrane segments may become permanently biased to close, depending on the flow (e.g., as an example, an energy flow and/or a waste flow) that passed along those specific membrane segments and the resulting apparent effect on the viability state of the unit. In other words, there may be a specialization of different boundary territories or segments over time. Crucially, this occurs based on the principle of causality/consequence, where structural adaptations are made that seem to have favorable consequences on the viability of the unit, such as decreasing the rate at which the unit is moving away from the viable range. More generally, influences from the medium on the unit leave traces, and influence from the unit on the medium as well. This can be an influence of flow but it could also be an influence of something like mechanical deformation of the medium.

Finally, the primitive architectural embodiment is notably characterized by an absence of global objective coordination or trajectory ranking. The primitive system is a system in which behavior and learning arise from strictly local boundary-level regulation under viability constraints, without reliance on global objective-driven optimization. The system operates such that action generation and structural adaptation are governed locally. No global reward, loss, value function, or trajectory evaluation coordinates behavior exists. Viability is enforced as a boundary condition on what can persist, not as a quantity to optimize; and memory is retained in structure, and structure directly determines behavior of the units in the medium and hence also how the medium affects the robot-medium boundary, which is where sensory information enters the medium and where medium influence can produce actuator output.

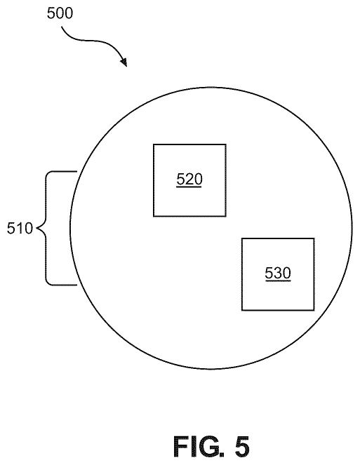

Now turning to FIG. 5, FIG. 5 is a block diagram illustrating an example of a bounded computational unit 500, according to an embodiment using the more primitive architecture as described earlier herein. The bounded computational unit 500 is a bounded region of space enclosed by a boundary, situated within a larger environment called the medium. Although the bounded computational unit 500 in FIG. 5 is depicted as a circle, it can be understood that the bounded computational unit 500 can be of any dimension, shape or size. For instance, the shape can be an oval or an ellipse shape, or any other shape that can be surrounded by a boundary. In some embodiments, the boundary can be a discontinuous boundary. For instance, the boundary may have a jagged edge. In contrast with the exemplary self-building internode network system 100 that is depicted in FIG. 1, viability is intrinsic to each local unit (e.g., bounded computational unit 500 of FIG. 5), rather than approximated at the network level, as exemplified by the self-building internode network system 100 (FIG. 1) With the self-building internode network system (FIG. 1), which operates on the graph level, the viability variables and the associated processes, such as energy uptake and waste removal, are more virtual, with resource for example not being carried by a medium, but flowing from a virtual reservoir that the nodes can directly access. It should also be noted that in some embodiments, the self-building internode network system 100 (FIG. 1) can be formulated without intrinsic viability to each local unit or node. With the self-building internode network system 100 (FIG. 1), one can make use of the highly-constrained interactions of the graph formulation, such as basing the network building operations on the amplification/suppression of causal activity between two nodes.

The collective viability regulation of multiple units inside of a medium, and their structural adaptation, constitute the behavior and learning of the body that is inhabited by the medium and units. The medium is coupled to the environment of the body through the medium-environment boundary, where parts of the boundary transmit outside influences to medium influences and parts of the boundary transmit medium influence to outside influence. This allows the units to respond to bodily input and cause bodily output by affecting the medium, such that adaptation of the units can lead to behavior of the body that supports the collective stabilization patterns of the units. The boundary segments have antagonistical actuators that open and close the segments selectively to resource and waste in order to regulate the unit's viability based on the four-state grammar, and have sensors that sense local physical processes that occur at the boundary, which are used to guide the instantaneous and structural responses of the unit such that the bounded computational local unit's behavior inherently depends on its metabolic state.

In some embodiments, the bounded computational unit 500 is a membrane-bound computation unit 500 having a membrane as its boundary, where the membrane includes membrane segments.

Each bounded computational unit 500 (sometimes referred to as “the unit”) maintains its own local condition relative to viability, regulates exchange with a surrounding medium, resolves its state based on condition and change, and makes structural adaptations based on physical residues produced by the unit's viability history and the physical processes that these direct. Also, the boundary or membrane may have many properties. It can also deform due to mechanical influence from the medium and it can cause the medium to deform, which is carried by the medium to then potentially affect other intermediate units or sensor and motor units, which additionally couple to a sensor or motor.

The bounded computational unit 500 includes boundary segments 510 of its boundary, and a plurality of viability variables 520 and 530. The plurality of viability variables 520 and 530 are local viability-regulating variables. Examples of viability variables include, but are not limited to, resource variables, burden variables, internal state variables, local state variables, depletion variables, accumulation variables, metabolic-state variables, heat/thermal burden, waste/residue/byproduct burden, structural stress/load, pressure, strain, instability, activation burden, structural cost, resource availability, and capacity/saturation state.

In some embodiments, the plurality of viability variables 520 and 530 include an energy function and a waste function. The boundary segments 510 are adaptable based on state history and local physical residues within the bounded computational unit 500. In some embodiments, the local physical residues include local flow traces. The plurality of viability variables 520 and 530 are configured to directly govern operations of the bounded computational unit 500, and where higher-level behavior and learning, which happens through structural adaptation of the units, based on the viability variables of the bounded computational unit 500, emerges from boundary-level (and internals-level) rules that use the viability variables and local traces. These viability variables are important to the life or viability of the bounded computational unit 500. If the bounded computational unit 500 has no energy, it cannot live. Or if it builds up too much waste, it cannot function. The bounded computational unit embodies certain aspects which demonstrate how the unit regulates itself. That is, things can go into the unit (such as energy), and things can exit the unit (such as waste), with the amounts depending on the properties of the unit and medium. It can have physical consequences, like deformations, which can be used to affect the medium, while it also can be sensitive to outside deformations, which could in turn have an effect on the boundary or membrane behavior. It may, for example, open up its boundary or membrane more when an external deformation imparts on it. If that frequently leads to improved viability, those membrane parts will adapt structurally to become more or less sensitive to such external influences.

In further embodiments, the bounded computational unit 500 exchanges energy and waste with its surroundings through the boundary. Such exchanges can take place at one or more boundary segments 510 of the bounded computational unit 500. As mentioned before, in some embodiments, the plurality of viability variables 520 and 530 comprise an energy function and the waste function, or for example solely an energy function that is affected by local waste properties.

Specifically, the energy function and the waste function of the bounded computational unit 500 act as viability variables (energy level, waste accumulation), which directly govern the unit's operational behavior. When a unit's energy drops or waste rises outside a defined viability range, local boundary-level rules could suppress costly operations and prioritize self-regulation that way, thereby making the unit's structural adaptation that results from the physical residues and viability history inherently dependent on its metabolic state.

Specifically, the boundary level-rules are rules that are dependent on the viability history of the bounded computational unit. As stated earlier herein, in state 1, where energy (or more generally, a viability variable) is above viability and the unit is moving away from viability, the unit wants to let in less resource and let out less waste. This reduces its energy (in the simulated example only energy is used as a viability variable, but waste affects the energy processes). If it is above viability but moving back towards viability, it will still want to close its boundary or membrane but less than when it was moving away from viability. Similarly, in states 3 and 4 below viability, it opens the membrane. Crucially, each part of the membrane has a separate set of opening and closing “actuators”, which leave behind a physical residue. If the viability situation of the unit is improving, these physical residues will be used to make one type of structural adaptation, while if the situation is worsening, it will make an opposite type of adaptation. Over time some part of the membrane might become permanently biased to open while another part might become permanently biased to close, depending on the physical residues and the resulting apparent effect on the viability state.

In other embodiments, the computation unit, like the node of the self-building internode network system 100 (FIG. 1), can operate or be in one of four transient node states at any given time. The four transient node states are based on two factors: the unit's deviation from a viability range, e.g. above/below/outside the range; and the unit's direction of change of that deviation, e.g. moving toward or away from viability. Thus, the four transient node states include the following: a first viability state when the unit deviates below a viability range and moves away from viability; a second viability state when the unit deviates below a viability range and moves towards viability; a third viability state when the unit deviates above a viability range and moves away from viability; and a fourth viability state when the unit deviates above a viability range and moves towards viability.

Importantly, self-regulation is always prioritized. The medium might fluctuate and hence push the unit away from viability, to which it then responds by trying to move back towards it.

In some embodiments, the boundary or membrane comprises a set of opening actuators and closing actuators which leave behind a physical residue to be used for structural adaptation of the local unit. Viability quantities like resource and waste can each have their own set of actuators, so that the permeability of the unit's boundary can be selectively controlled.

Specifically, structural adaptation at this level occurs at the boundary itself: portions of the boundary become biased to open or close based on the unit's history of state transitions and the specific viability behavior (such as slow versus fast increase, or being very far from viability versus only a bit), with molecular-residue-style activity traces along each boundary segment recording the flow of material, or for example recording concentration differences, so that when a viability trajectory of a unit results in a specific way of adaptation the unit can identify which boundary regions or boundary segments 510 were most active and modify their permeability accordingly.

The bounded computational unit 500 supports a bounded local domain, local residues and viability-related traces, local viability-relevant state, evaluation of viability relative to sufficiency and change, interaction with a surrounding medium, and local modification of structure, coupling, or boundary behavior. It should be noted that no specific chemistry, sensor set, or hardware implementation is required for the implementation of the bounded computational unit 500. Instead, viability is intrinsic to each unit, signaling is fully derived from consequence, and structure formation includes boundary and exchange dynamics. It should also be noted that sensors and motors couple to special boundary regions or units, which in turn influence the medium, through which it influences the other units, or which are influenced by the medium. More generally, an outside influence may also simply cause some kind of influence on the medium, such as touch causing deformation, without needing a dedicated sensory interface or units. This deformation can then affect the viability of the units living inside of the medium and thereby affect their structural adaptation.

There are several notable core characteristics regarding a system that utilizes the bounded computational unit 500. First, the system uses bounded local units. Each unit (e.g., the bounded computational unit 500) has an interior, an exterior, and an interface through which influence from and to a medium occurs. Second, there is a local state relative to viability. That is, each unit maintains one or multiple variables relevant to persistence (e.g., resource, burden, load, or analogous quantities), without requiring a specific implementation. Third, a state-dependent regulation exists, such that behavior is determined by local state relative to sufficiency, by the direction of change of that state, and its history as well. Fourth, there is a local-only adaptation. This means that all changes in structure, thresholds, or coupling occur locally, without centralized coordination. That is, each unit coordinates its own “sensors and motors”, which are located throughout it, such as the opening and closing boundary motors.

Fifth, the system implements body-medium coupling. That is, the units interact through a shared medium that supports propagation of consequence (e.g., gradients, mechanical deformation of medium, transport, or diffusion-like processes). Sixth, the system implements derived signaling. That is, signals are not predefined primitives. They arise as recurring consequences of local regulation that stabilizes a unit under influence from the medium. This gives rise to unit specialization and signaling. They become reusable mediators of interaction. Finally, the system provides collective emergence. When many such units of the system are coupled, signaling fields emerge, antagonistic regulation arises, local territories differentiate, and central-like convergence regions can form. By affecting and being affected by the processes that occur at the medium-environment boundary, the units can learn to react to sensory input and produce motor output as a way to improve their viability stabilization.

Thus, it can be said that exemplary systems can be composed of bounded computational units (bounded local units) that regulate viability through local state and can influence or be influenced by the medium, depending on its viability history in various ways. Over time these patterns consolidate as structural adaptation. Viability is intrinsic to each unit. Such systems have architectures in which signaling, coordination, and structure emerge from repeated local interaction. Signaling is fully derived from consequence. Signals arise as recurring consequences of local regulation that stabilizes a unit under influence from the medium. This gives rise to unit specialization and signaling. They become reusable mediators of interaction. As a result, inter-unit signaling via the medium can come to exist, and can become crucial to the collective stabilization of the units. Furthermore, these systems are where sensing and acting arise as asymmetries within a shared local-unit architecture. One part of a unit could for example develop to become highly sensitive to influence from the medium, whereas other parts might develop to frequently affect the medium, if that has caused the viability stabilization to improve over time. Such systems can be considered substrates in which a body and a medium are part of the learning process. Structure formation includes boundary and exchange dynamics.

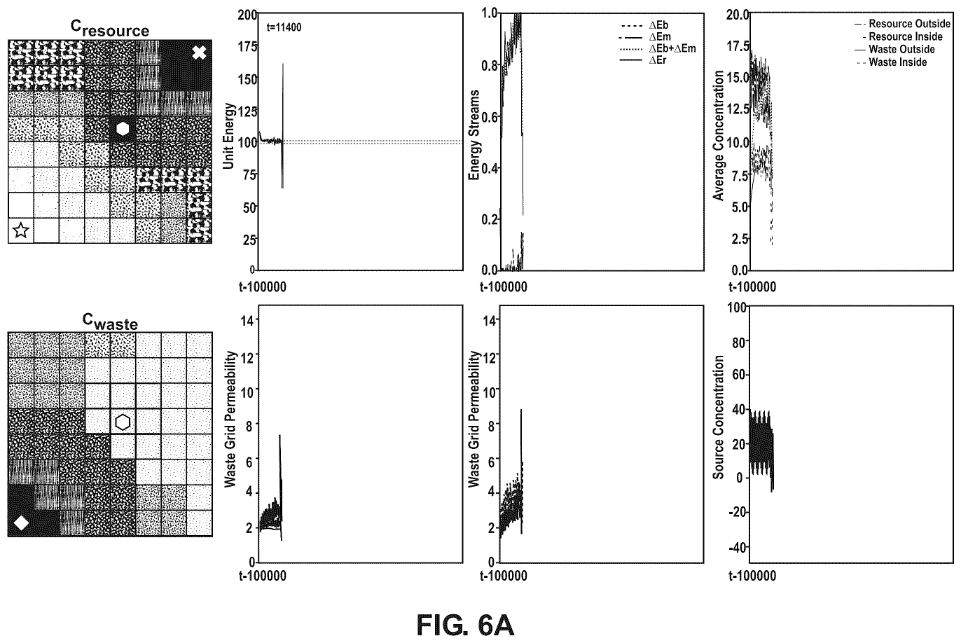

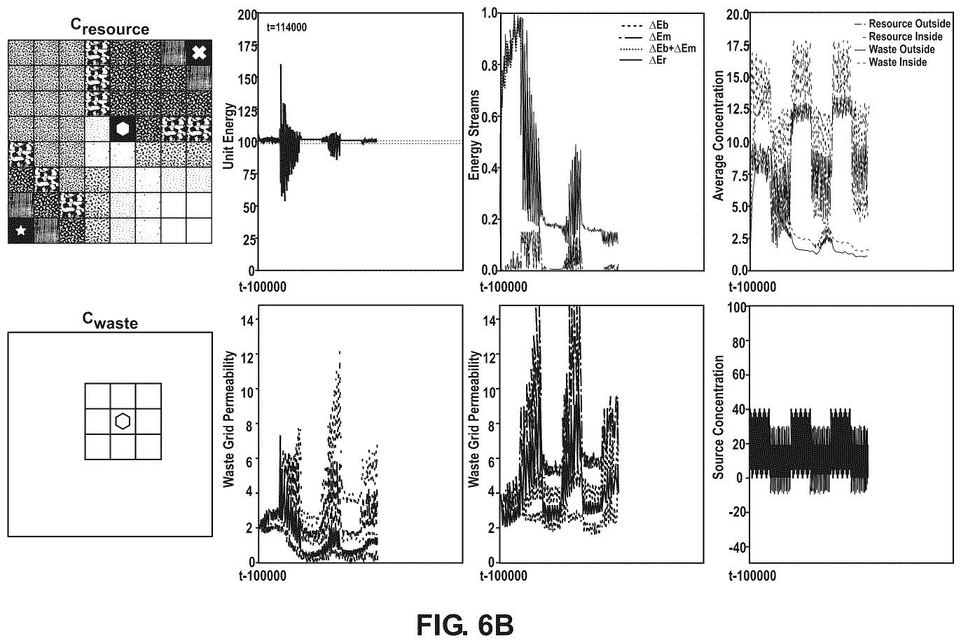

Referring now to FIGS. 6A and 6B, FIGS. 6A and 6B are screenshots of a bounded computational unit, according to an embodiment. In this embodiment, the unit has a membrane as its boundary and its viability function is only an energy function that is affected by waste. As shown in the screenshots, Delta E_b refers to the basal energy cost of the unit that it spends to maintain itself. Delta E_m refers to the cost of the membrane response. Delta E_b+Delta E_m refers to the total energy cost. Delta E_r refers to the energy increment gained from conversion of resource to waste.

Referring still to FIGS. 6A and 6B, as an example, energy can flow in and waste can flow out of the unit via its membrane. The unit operates in an environment or a medium. The unit actively regulates itself. Otherwise, if the unit does not gain energy, or it is not getting rid of its waste, then the unit's operations will be affected. Structural adaptation occurs at the unit's membrane. Based on the unit's viability history (such as how the unit's local state changes and how its environment changes), the unit can make structural adaptations.

As described earlier herein, the unit can operate in one of four states, and thus, the unit's membrane can make adaptations based on the current state of the unit. Across the membrane segments of the membrane, the unit has some memory of a flow or an exchange of molecules that occurred at the level of the membrane. Alternatively, the unit has a residue which leaves a trace based on the unit's history. The unit can control the permeability of its membrane, such that the unit can adapt to its environment. As an example, the unit can open a portion of its membrane so that energy molecules can flow into the unit, when the unit's energy is low.

### Exemplary Use Cases

The present disclosure provides an autonomous self-building internode network system that uses the graph formulation with internodes and can be used with any physical AI, to perform any number of tasks, including a wide spectrum of tasks from doing laundry and dishes to mining asteroids. Furthermore, although the present disclosure described a robot having sensors and motors, the present disclosure is not limited to such embodiments. The present disclosure also includes bounded computational units, viability-based units that live in a shared medium that is influenced by the environment at the medium boundaries, that, unlike the self-building internode network system, do not use graph formulation with internodes. The present disclosure also describes robots having general input nodes and general output nodes. These input and output nodes can in principle receive and transmit anything. The input nodes can receive sensor values from physical sensors, and the output nodes can transmit motor signals that can be converted into action at the robot's motors. In one exemplary embodiment, the network is governing a general input->output process, simply producing symbols from symbols. As described earlier herein, the present disclosure includes a sensible way to have reinforcement for the robot and for the robot's learning to be directed in a way that can be used for streamlined learning of practical behaviors. Initial reinforcements stem from the network initialization. Since those need to exist in order for learning to occur by connecting different nodes, there needs to be some initial wiring. Importantly, this all holds only for the self-building internode network system 100 (FIG. 1). For the bounded computation unit, which can be considered to be a more general version of the self-building internode network system 100 (FIG. 1), one does not use internodes and a neuromodulator-like structure from the beginning. Instead, such structures would have to emerge or arise from structural adaptations of the bounded computation units based on the boundary- and viability-based rules as described earlier herein.

The exemplary systems and units described herein can also be applied to “intellectual” AI like chatbots, Self-Adaptive Communication Networks (particularly enhancing SDN-based infrastructures), or even to video games, where virtual characters can evolve autonomously in their game worlds. The exemplary systems and units can also be utilized in self-driving or autonomous cars. Further use cases include, but are not limited to the following:
Autonomous Ground Vehicles (self-driving cars; autonomous delivery robots; agricultural machinery; e.g., automated tractors);
Aerial Vehicles (autonomous drones, e.g., delivery, inspection, surveillance; passenger aircraft autopilots; military UAVs);
Maritime Systems (autonomous ships and submarines; underwater exploration drones);
Space Exploration Robots (rover navigation, e.g., Mars rover, autonomous asteroid-mining robots);
Domestic and Service Robots (household robots, e.g., cleaning, sorting);
Healthcare and companion robots (including humanoids);
Industrial Automation (autonomous manufacturing equipment; warehouse automation robots, e.g., sorting, transport);
Construction and Infrastructure Robotics (e.g., autonomous construction vehicles, maintenance and inspection robots);
Search and Rescue Robots (autonomous disaster response and hazardous environment navigation);
Assistive and Rehabilitation Robotics (e.g., mobility assistance devices, adaptive prosthetics);
Security and Defense Robotics (autonomous perimeter surveillance, autonomous patrol robots);
Environmental Monitoring and Agricultural Robotics (e.g., autonomous environmental sensing and adaptive farming systems);
Entertainment and Interactive Robots (adaptive entertainment robots, autonomous interactive toys).

In one aspect, a self-building internode network system is provided. The self-building internode network system comprises a plurality of internodes, including input nodes and output nodes; a sensor and a motor coupled to the plurality of internodes; and a self-building network module. The self-building network module is operatively coupled to the plurality of internodes, the sensor and the motor. The self-building network module is configured to implement an automatic experience-driven network construction algorithm to build the network system based on internally generated reinforcement from sensory processing of the sensor, network activity of the plurality of internodes, and reflex-first learning in which reflexive behavior precedes higher-order processing structures. The self-building network module is further configured to initiate staged internode spawning of the plurality of internodes based on causal firing activity between the plurality of internodes, local activity traces, causal activity relationships, co-activation history, or other locally available interaction-derived signals. The self-building network module further includes an adaptive threshold scaling based on threshold scaling with total incoming edge strength of a given internode, which stabilizes firing activity of the given internode. The self-building internode network system is configured to interact within an environment that the self-building internode network system experiences only through the sensor and in which the self-building internode network system produces actions through the motor to create learned behaviors and memories. The learned behaviors and memories reside solely in a network topology, connection strengths, and transient node states of the plurality of internodes that are produced and driven by positive or negative experiences of the self-building internode network system in the environment as derived from the sensory processing, without external memory or a central control unit.

The self-building internode network system interacts with its environment. Also, the network activity both generates internal reinforcement signals and autonomously instantiates new internodes and edges, incrementally forming the higher-order processing structures.

The self-building network module implements decentralized adaptive learning; and formation of the internode network system network and the reflex-first learning are incremental.

The reflexive behavior yields a positive experience or negative experience, before a complex, adaptive structure emerges to govern output of the motor of the self-building internode network system. Automatic network building of the self-building internode network system is configured to be selectively paused or re-enabled at any time.

In some embodiments, the self-building internode network system comprises a robot having a robot body. The robot body is communicatively coupled to the sensor and the motor. The robot is further configured to interact within an environment that the robot experiences only through the sensor and in which the robot produces actions through the motor, such as to create the robot's learned behaviors and memories, where the robot's learned behaviors and the robot's memories reside solely in an network topology and its specific edge strengths and transient node states of the self-building internode network system that are produced and driven by the robot's positive experiences or negative experiences in the environment derived from the sensory processing. The robot's memories further reside in its node properties, including thresholds. The robot's positive experiences or negative experiences in the environment are further derived from its viability history.

The self-building network module is further configured to provide structural adaptation, the structural adaptation including a deletion of an internode, a spawning of an existing edge, a deletion of an existing edge or a modification of an existing edge.

In response to the structural adaptation, a network modification is induced. The self-building internode network system experiences, via the sensor, neuromodulator node activity. The reflexive behavior comprises initially reflexive sensor-to-motor connections.

In some embodiments, the self-building internode network is tested for a failure mode. The failure mode is activated when behavior of a tested self-building internode network collapses into task-specific tuning, requires retraining to adapt, fails to remain coherent when learning is paused, or exhibits global objective computation.

In some embodiments, each node of the input nodes and the output nodes updates its viability only based on locally available information. Viability of a node is determined by its viability variables.

The viability of a node is determined by its behavior in response to its viable ranges, which in turn influences its transient responses and the structural adaptation of the node.

In further embodiments, a node of the input nodes and the output nodes is in one of four transient node states. The four transient node states include: a first viability state when the node deviates below a viability range and moves away from viability; a second viability state when the node deviates below a viability range and moves towards viability; a third viability state when the node deviates above a viability range and moves away from viability; and a fourth viability state when the node deviates above a viability range and moves towards viability.

Another aspect of the present disclosure provides a method comprising: establishing a plurality of internodes, having types of both input nodes and output nodes, interacting within an environment by experiences through neuromodulator node activity or a sensor; producing actions through a motor, to create learned behaviors and memories; reinforcing the learned behaviors and memories based on: the neuromodulator node activity or sensory processing of the sensor; network activity based on activity of the plurality of internodes; and reflex-first learning that expands into higher-order structure; and staged internode spawning of the internodes based on causal firing activity between the plurality of internodes, local activity traces, causal activity relationships, co-activation history, or other locally available interaction-derived signals.

In some embodiments, the internodes include one or more intermediate nodes.

Reflex first learning expands into viability history. The method further comprises incrementally forming an internode network system by coupling the motor, the one or more sensors and the plurality of internodes with a self-building network module configured to implement an automatic experience-driven network construction algorithm to build the network system.

Interacting within the environment by experiences through the sensor further comprises generating internal reinforcement signals and autonomously instantiating new internodes and dynamic signal relays, to incrementally form higher-order processing structures.

In some embodiments, the method further comprises implementing decentralized adaptive learning. The method further may include pausing and then re-starting the incremental formation of the internode network system.

In yet another aspect of the present disclosure, a bounded computational local unit is described. The computational local unit has an interior, an exterior, and an interface through which exchange occurs. The interface is a boundary having boundary segments. The computational local unit further comprises a plurality of viability variables, and it operates in a local state that corresponds to its viability. Its boundary segments are adaptable based on boundary—based viability regulation, the computational local unit's viability history and local physical residues within the computational local unit. The plurality of viability functions is configured to directly govern operations of the computational local unit. Higher-level network-like behavior of the computational local unit emerges from boundary-level rules that use the plurality of viability variables.

In some embodiments, the interior of the computation local unit comprises interior segments which are adaptable based on interior-based viability regulation, and where the higher-level network-like behavior of the computational unit emerges from interior-level rules that use the plurality of viability variables.

In other embodiments, structural adaptations of the local unit are based on consequence and causality where biases are strengthened when they have favorable consequences for viability, and where biases weakened when they have unfavorable consequences for viability.

In further embodiments, the plurality of variability variables of the bounded computational local unit includes energy, wherein the bounded computational local unit exchanges resource and waste with its surroundings through the boundary at one or more boundary segments. When energy drops or waste rises of the bounded computational local unit outside a defined viability range, local boundary-level rules suppress operations and prioritize self-regulation, making the computational local unit's structural adaptation inherently dependent on its metabolic state.

In some embodiments, the plurality of viability variables includes an energy function and a waste function.

In other embodiments, the computational local unit further comprises a membrane-bounded computational unit having membrane segments.

The bounded computational local unit can be in one of four transient node states. The four transient node states include: a first viability state when the bounded computational local unit deviates below a viability range and moves away from viability; a second viability state when the bounded computational local unit deviates below a viability range and moves towards viability; a third viability state when the bounded computational local unit deviates above a viability range and moves away from viability; and a fourth viability state when the bounded computational local unit deviates above a viability range and moves towards viability.

In further embodiments, the membrane of the computational local unit comprises a set of opening actuators and closing actuators which leave behind a physical residue to be used as a basis for structural adaptation of the local unit.

An exemplary self-building internode network system includes a plurality of internodes, a sensor and motor, and a self-building network module coupled to the plurality of internodes, the sensor and the motor. The self-building network module implements an automatic experience-driven network construction algorithm for network building. The self-building network module initiates staged internode spawning of the internodes. In the self-building network module may also perform deletion and create, delete or modify edges. The network system produces actions through the motor to create learned behaviors and memories. Neuromodulator activity plus sensor and internode activity are also crucial parts for the formation of learned behavior and memories. Learned behaviors and memories reside solely in a network topology, connection strengths, local node properties, and transient node states, without external memory or a central control unit. Another embodiment provides a primitive bounded computational local unit. The unit includes viability variables and uses its local capabilities to regulate its viability based on its current viability state and its viability history. Structural adaptations are made at the boundary and in the interior of the unit, based on its viability history and local physical residues. Higher-level network-like behavior emerges from unit-level rules that use the plurality of viability variables.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “language model” refers to any type of automated agent that communicates via natural language. For instance, a language model can be implemented as a neural network, e.g., a decoder-based generative language model such as versions of ChatGPT, Gemini, Chameleon, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. Thus, a “generative language model” is a model that can generate new sequences of text given some input prompt, e.g., a query potentially with some additional context.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query.

The term “data health issue” refers to any characteristic of a dataset that could impact results of processing that dataset. Examples of data health issues include the presence of corrupted data, erroneous data, improperly formatted data, statistical outliers, etc. The term “data evaluation action” refers to any action performed on a dataset that can identify a data health issue. A “data evaluation plan” is one or more data evaluation actions that can be performed on a given dataset. A “data cleaning action” is an action that attempts to improve data quality by correcting at least one data health issue, e.g., by removing an entry or value from a dataset, changing a value in the dataset to a different value, etc.

A “summary” of a dataset refers to a representation of the dataset as a whole. A summary of a dataset can include data types of fields of the dataset, statistical information for fields of the dataset, and/or annotations of individual fields of the dataset, a set of fields of the dataset, or the dataset as a whole. A “data health score” refers to any metric that characterizes the presence of data health issues in a dataset. A “severity dictionary” is one or more indications of how severe a particular type of data health issue is when present in a dataset. For instance, a severity dictionary can indicate that missing values are relatively more severe than statistical outliers, and can include weights designating the relative severity of each.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Decoder-Based Language Model

An example generative language model is now described that can be employed using the disclosed implementations. This generative language model is an example of a machine learning model that can be used to perform one or more natural language processing tasks that involve generating text, as discussed more below. For the purposes of this document, the term “natural language” means language that is normally used by human beings for writing or conversation.

The generative language model can receive input text, e.g., a prompt from a user. For instance, the input text can include words, sentences, phrases, or other representations of language. The input text can be broken into tokens and mapped to token and position embeddings representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings are processed in one or more decoder blocks. Each decoder block implements masked multi-head self-attention, which is a mechanism relating different positions of tokens within the input text to compute the similarities between those tokens. Each token embedding is represented as a weighted sum of other tokens in the input text. Attention is only applied for already-decoded values, and future values are masked. Layer normalization normalizes features to mean values of 0 and variance to 1, resulting in smooth gradients. A Feed forward layer transforms these features into a representation suitable for the next iteration of decoding, after which another layer normalization is applied. Multiple instances of decoder blocks can operate sequentially on input text, with each subsequent decoder block operating on the output of a preceding decoder block. After the final decoding block, a text prediction layer can predict the next word in the sequence, which is output as output text in response to the input text and also fed back into the language model. The output text can be a newly-generated response to the prompt provided as input text to the generative language model.

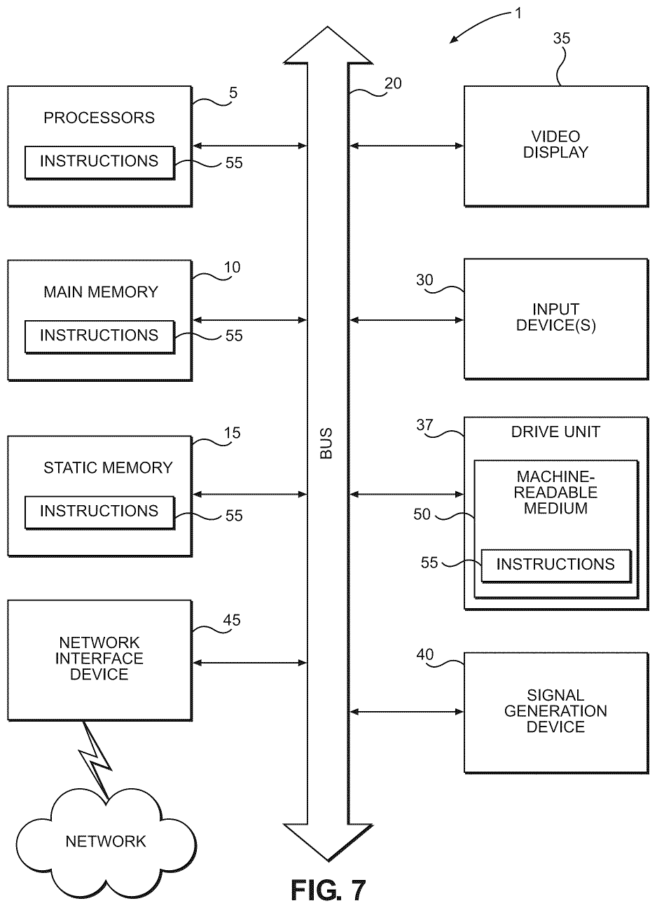

FIG. 7 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present disclosure. However, it will be apparent to one skilled in the art that the present disclosure may be practiced in other embodiments that depart from these specific details.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

1. A self-building internode network system comprising:
a plurality of internodes, including input nodes and output nodes;
a sensor and a motor coupled to the plurality of internodes; and
a self-building network module operatively coupled to the plurality of internodes, the sensor and the motor, the self-building network module configured to implement an automatic experience-driven network construction algorithm to build the network system based on internally generated reinforcement from sensory processing of the sensor, network activity of the plurality of internodes, and reflex-first learning in which reflexive behavior precedes higher-order processing structures,
the self-building network module further configured to initiate staged internode spawning of the plurality of internodes based on causal firing activity between the plurality of internodes, local activity traces, causal activity relationships, co-activation history, or other locally available interaction-derived signals,
the self-building network module further including an adaptive threshold scaling based on threshold scaling with total incoming edge strength of a given internode, which stabilizes firing activity of the given internode,
the self-building internode network system configured to interact within an environment that the self-building internode network system experiences only through the sensor and in which the self-building internode network system produces actions through the motor to create learned behaviors and memories, and
the learned behaviors and memories residing solely in a network topology, connection strengths, and transient node states of the plurality of internodes that are produced and driven by positive or negative experiences of the self-building internode network system in the environment as derived from the sensory processing, without external memory or a central control unit.

2. The self-building internode network system of claim 1, wherein as the internode network system interacts with its environment, the network activity both generates internal reinforcement signals and autonomously instantiates new internodes and edges, incrementally forming the higher-order processing structures.

3. The self-building internode network system of claim 1, wherein:
the self-building network module implements decentralized adaptive learning; and
formation of the internode network system network and the reflex-first learning are incremental.

4. The self-building internode network system of claim 1, wherein the reflexive behavior yields a positive experience or negative experience, before a complex, adaptive structure emerges to govern output of the motor of the self-building internode network system.

5. The self-building internode network system of claim 1, wherein automatic network building of the self-building internode network system is configured to be selectively paused or re-enabled at any time.

6. The self-building internode network system of claim 1, further comprising:
a robot having a robot body, the robot body communicatively coupled to the sensor and the motor, the robot being further configured to interact within an environment that the robot experiences only through the sensor and in which the robot produces actions through the motor, such as to create the robot's learned behaviors and memories, where the robot's learned behaviors and the robot's memories reside solely in an network topology and its specific edge strengths and transient node states of the self-building internode network system that are produced and driven by the robot's positive experiences or negative experiences in the environment derived from the sensory processing.

7. The self-building internode network system of claim 1, wherein the self-building network module is further configured to provide structural adaptation, the structural adaptation including a deletion of an internode, a spawning of an existing edge, a deletion of an existing edge or a modification of an existing edge.

8. The self-building internode network system of claim 7, wherein in response to the structural adaptation, a network modification is induced.

9. The self-building internode network system of claim 1, wherein the self-building internode network system experiences, via the sensor, neuromodulator node activity.

10. The self-building internode network system of claim 6, wherein the robot's memories further reside in its node properties, including thresholds.

11. The self-building internode network system of claim 6, the robot's positive experiences or negative experiences in the environment are further derived from its viability history.

12. The self-building internode network system of claim 1, wherein the reflexive behavior comprises initially reflexive sensor-to-motor connections.

13. The self-building internode network system of claim 1, wherein the self-building internode network is tested for a failure mode.

14. The self-building internode network system of claim 13, wherein the failure mode is activated when behavior of a tested self-building internode network collapses into task-specific tuning, requires retraining to adapt, fails to remain coherent when learning is paused, or exhibits global objective computation.

15. The self-building internode network system of claim 1, wherein each node of the input nodes and the output nodes updates its viability only based on locally available information.

16. The self-building internode network system of claim 1, wherein the viability of a node is determined by its viability variables.

17. The self-building internode network system of claim 1, wherein the viability of a node is determined by its behavior in response to its viable ranges, which in turn influences its transient responses and the structural adaptation of the node.

18. The self-building internode network system of claim 1, wherein a node of the input nodes and the output nodes is in one of four transient node states, the four transient node states comprising:
a. a first viability state when the node deviates below a viability range and moves away from viability;
b. a second viability state when the node deviates below a viability range and moves towards viability;
c. a third viability state when the node deviates above a viability range and moves away from viability; and
d. a fourth viability state when the node deviates above a viability range and moves towards viability.

19. A method, comprising:
establishing a plurality of internodes, having types of both input nodes and output nodes,
interacting within an environment by experiences through neuromodulator node activity or a sensor;
producing actions through a motor, to create learned behaviors and memories;
reinforcing the learned behaviors and memories based on:
the neuromodulator node activity or sensory processing of the sensor;
network activity based on activity of the plurality of internodes; and
reflex-first learning that expands into higher-order structure; and
staged internode spawning of the internodes based on causal firing activity between the plurality of internodes, local activity traces, causal activity relationships, co-activation history, or other locally available interaction-derived signals.

20. The method of claim 19, wherein the internodes include one or more intermediate nodes.

21. The method of claim 19, wherein reflex-first learning that expands into viability history.

22. The method of claim 19, further comprising incrementally forming an internode network system by coupling the motor, the one or more sensors and the plurality of internodes with a self-building network module configured to implement an automatic experience-driven network construction algorithm to build the network system.

23. The method of claim 19, wherein interacting within the environment by experiences through the sensor further comprises generating internal reinforcement signals and autonomously instantiating new internodes and dynamic signal relays, to incrementally form higher-order processing structures.

24. The method of claim 19, further comprising implementing decentralized adaptive learning.

25. The method of claim 21, further comprising pausing and then re-starting the incremental formation of the internode network system.

26. A bounded computational local unit having an interior, an exterior, and an interface through which exchange occurs, the interface being a boundary having boundary segments the computational local unit further comprising a plurality of viability variables, the computational local unit operating in a local state that corresponds to its viability, the boundary segments being adaptable based on boundary-based viability regulation, the unit's viability history and local physical residues within the computational local unit, the plurality of viability functions configured to directly govern operations of the computational local unit, and where higher-level network-like behavior of the computational unit emerges from boundary-level rules that use the plurality of viability variables.

27. The bounded computational local unit of claim 26, wherein the interior comprises interior segments which are adaptable based on interior-based viability regulation, and where the higher-level network-like behavior of the computational unit emerges from interior-level rules that use the plurality of viability variables.

28. The bounded computational local unit of claim 26, wherein structural adaptations of the local unit are based on consequence and causality where biases are strengthened when they have favorable consequences for viability, and where biases weakened when they have unfavorable consequences for viability.

29. The bounded computational local unit of claim 26, wherein the plurality of variability variables of the bounded computational local unit includes energy, wherein the bounded computational local unit exchanges resource and waste with its surroundings through the boundary at one or more boundary segments.

30. The bounded computational local unit of claim 29, wherein when energy drops or waste rises of the bounded computational local unit outside a defined viability range, local boundary-level rules suppress operations and prioritize self-regulation, making the bounded computational local unit's structural adaptation inherently dependent on its metabolic state.

31. The bounded computational local unit of claim 26, wherein the plurality of viability variables includes an energy function and a waste function.

32. The bounded computational local unit of claim 26 further comprising a membrane-bounded computational unit having membrane segments.

33. The bounded computational local unit of claim 26, wherein the bounded computational local unit is in one of four transient node states, the four transient node states comprising:
a. a first viability state when the bounded computational local unit deviates below a viability range and moves away from viability;
b. a second viability state when the bounded computational local unit deviates below a viability range and moves towards viability;
c. a third viability state when the bounded computational local unit deviates above a viability range and moves away from viability; and
d. a fourth viability state when the bounded computational local unit deviates above a viability range and moves towards viability.

34. The bounded computational local unit of claim 32, wherein the membrane comprises a set of opening actuators and closing actuators which leave behind a physical residue to be used as a basis for structural adaptation of the local unit.
